(19) United States
(12) Patent Application Publication
(10) Pub. No.: US 2017/0105407 A1
(43) Pub. Date: Apr. 20, 2017

(54) COMPOSITIONS AND METHODS FOR ENHANCING RED BLOOD CELL STORAGE TIME AND SURVIVABILITY USING NITRIC OXIDE RELEASING HYBRID HYDROGEL NANOPARTICLES

(71) Applicants: ALBERT EINSTEIN COLLEGE OF MEDICINE, INC., Bronx, NY (US); University of California San Diego, La Jolla, CA (US)

(72) Inventors: Joel M. FRIEDMAN, South Orange, NJ (US); Pedro CABRALES, La Mesa, CA (US); Adam J. FRIEDMAN, New York, NY (US)

(21) Appl. No.: 15/312,080

(22) PCT Filed: May 21, 2015
(86) PCT No.: PCT/US15/31907

§ 371 Date: Nov. 17, 2016

Related U.S. Application Data
(60) Provisional application No. 62/001,391, filed on May 21, 2014.
(60) Provisional application No. 62/064,251, filed on Oct. 15, 2014.

(51) Int. Cl. A01N 1/02

(52) U.S. Cl. CPC A01N 1/0226; A01N 1/0215

(57) ABSTRACT

Described herein are hydrogel-based nanoparticles which release nitric oxide (NO) or other bioactive forms of NO including nitrosothiols, nitrofatty acids and dinitrogen trioxide into stored red blood cells (RBCs). Also provided herein is a method for using hydrogel-based nanoparticles to supplement stored RBCs with NO to enhance red blood cell (RBC) storage time, improve survivability in circulation, minimize toxicity associated with transfusion, and improve transfusion safety by eliminating infective organisms in stored blood.

### RELATED APPLICATIONS

This application claims the benefit of U.S. provisional application Ser. No. 62/001,391, filed May 21, 2014 and U.S. provisional application Ser. No. 62/064,251, filed Oct. 15, 2014, which are hereby incorporated by reference in their entireties.

### 1. INTRODUCTION

Disclosed herein is composition for enhancing red blood cell or whole blood storage time and survivability. Also disclosed is an additive for red blood cells (RBCs) or whole blood. In one or more embodiments, the additive is a composition to improve blood storage and/or rejuvenate stored blood. In one or more embodiments, the composition comprises a hydrogel based nanoparticle. In one or more embodiments, the nanoparticle is capable of sustained release of nitric oxide (NOnp) or other bioactive forms of nitric oxide. In certain embodiments, the bioactive form of nitric oxide is a nitrosothiol, a nitrofatty acid, a dinitrogen trioxide, a diazeniumdiolate (NONOate), a nitric oxide releasing organic molecule or any combinations thereof. In one or more embodiments, the additive enhances RBC storage time, improves RBC survivability in circulation, minimizes toxicity associated with transfusion, and/or improves transfusion safety by eliminating infective organisms in stored blood. Also disclosed herein is a method of enhancing red blood cell storage time and survivability using the disclosed NOnp. Also disclosed is a method for treating red blood cells or whole blood. In certain embodiments, the method improves the quality of the red blood cells or whole blood during storage. In certain embodiments, the method rejuvenates the red blood cells or whole blood.

### 2. BACKGROUND

Blood storage is a necessary medical logistical activity. Patients who require blood transfusions often need them in a timely fashion and may need a particular blood type. In order to assure the availability of blood for patients in need, blood storage agencies must keep an inventory available at all times. Available blood must be fresh and its red blood cells (RBCs) must be able to adequately transfer oxygen to bodily tissues, otherwise the transfusion will be ineffective in improving a patient's condition. RBCs contain hemoglobin, a complex iron-containing protein that carries oxygen throughout the body. The availability of RBCs in blood may be measured by the hematocrit, which is percentage of blood volume that is composed of RBCs. The average hematocrit in adult males is 47%. In two or three drops of blood, there are about one billion RBCs, and for every 600 RBCs, there are about 40 platelets and one white blood cell.

Blood banks separate blood into its components (RBCs, white blood cells, platelets) and generally transfuse only the portion that is necessary. The separation of blood components damages the RBCs though, by causing storage lesions characterized by a decrease in the marker 2,3-diphosphoglycerate (2,3-DPG), an increase in the production of oxygen free radicals and a change in morphology.

Conventional blood storage methods include acid citrate dextrose (ACD), citrate-phosphate-dextrose solution (CPD) and citrate-phosphate-dextrose-adenine solution (CPDA) or a combination thereof. Citrate or other anticoagulants are useful to prevent clotting. An energy source such as dextrose may be added to maintain blood's metabolic functions even at refrigerated temperatures. Phosphate ion may be used to buffer the lactate produced from dextrose utilization. In certain embodiments, the anticoagulant is hirudin, heparin, coumarin, warfarin, dicumarol, aspirin or a combination thereof,

However, conventional methods of storing blood limit its shelf life to up to 42 days. After 42 days, many cells have become senescent and would be immediately phagocytized upon transfusion into a recipient. RBCs are subject to progressive degradation of the cells over time (formation of microparticles which are the alleged proinflammatory agents in transfused blood), which results in enhanced rates of hemolysis and physical properties that enhance the rate of clearance from the circulation (e.g. increase in membrane rigidity). Stored blood is also subject to increased stiffness and shortened circulation time. After removal from the body, the level of NO begins to drop until the blood expires (usually around the 42 day point). At this point, the level of NO is almost nonexistent and the RBCs are incapable of effectively accepting, transferring, and unloading oxygen to tissue.

Furthermore, as stored blood ages, the chances of morbidity resulting from a transfusion increases. Morbidity occurs by hemolysis of aged RBCs. Hemolysis releases free hemoglobin into circulation. Free acellular hemoglobin is pro-inflammatory. In addition, acellular hemoglobin effectively scavenges NO. This further exacerbates inflammation and causes vasoconstriction, which minimizes tissue perfusion and undermines the purpose of the transfusion. The consequences of free acellular hemoglobin are especially significant when the transfusion recipient already has underlying vascular inflammation, such as the type caused by metabolic syndrome, Type II diabetes, hemorrhage, and many hemoglobinopathies.

Stored blood also faces the problem of contamination with infectious agents as new organisms appear in the blood supply. This problem becomes an issue as new immigrant populations introduce new pathogens into the blood supply. Contaminated blood poses the risk of passing on life-threatening infections to patients receiving the blood.

Since blood must be donated, which thereby limits the total availability of transfusable blood, and expired blood is no longer viable for transfusion, there are compelling economic and medical needs to extend the shelf life of store blood. There is also a need for a method to rejuvenate blood and RBCs which are functioning sub-optimally. There exists a need in the art for mechanisms and/or a clinically plausible approach to using NO to slow the rate of stored RBC degradation. There further exists a need in the art for ways to reduce morbidity and contamination associated with stored blood. Reducing or eliminating the toxicity associated with blood transfusions would reduce costs and improve safety associated with blood transfusions.

### 3. SUMMARY

NO is a vital component of mammalian host defense, produced in and by cells comprising the innate immune system, most importantly macrophages. NO is unique as an antimicrobial agent as it can inhibit or kill a broad range of microorganisms. NO can interact with and alter protein thiols and metal centers, blocking essential microbial physiological processes, including respiration and DNA replication. Peroxynitrite (ONOO), which is formed by oxidation of NO, nitrogen dioxide (NO₂), dinitrogen trioxide (N₂O₃), and nitroxyl ions induce oxidation of key pathogen machinery. Furthermore, these species can initiate continuous lipid peroxidation reactions, adding to NO's antimicrobial power. Maintaining NO in stored blood for its antimicrobial effect is significant in limiting contaminations. To achieve these objects, a NO releasing nanoparticle (NOnp) that can release NO in a sustained fashion is desired.

It is therefore an object of the present disclosure to provide a hydrogel nanoparticle for release of nitric oxide (NO) as an additive to: enhance red blood cell (RBC) or whole blood storage time, improve RBC survivability in circulation, minimize toxicity associated with transfusion, and improve transfusion safety by eliminating infective organisms in stored blood. It is a further object of the present disclosure to provide a method of storing and/or rejuvenating blood using a hydrogel nanoparticle for release of nitric oxide.

Provided herein is a composition comprising a hydrogel nanoparticle for supplementing stored blood. In one or more embodiments, the nanoparticle releases nitric oxide (NOnp). In other embodiments, the nanoparticle releases a nitrosothiol, a nitro-fatty acid, a dinitrogen trioxide, a diazeniumdiolate (NONOate), a nitric oxide releasing organic molecule or any combination thereof. In certain embodiments, the nanoparticle comprises one or more anti-inflammatory agent.

A red blood cell or whole blood is aged when it has been removed from circulation in a human or an animal. A red blood cell or whole blood may be aged for 1, 2, 3, 4, 5-10, 10-15, 15-20, 20-25, 25-30, 30-35, 35-40, 41, 42 or 43-45 days. In one embodiment, the red blood cell or whole blood is returned to circulation in a human or an animal. In one or more embodiments, the red blood cell or whole blood is returned to circulation in a human or an animal after it is contacted with the composition disclosed herein. In certain embodiments, the red blood cell or whole blood is returned to circulation in a human or an animal with the composition disclosed herein.

In one aspect, the present disclosure provides a composition for blood storage and/or rejuvenation. Provided herein is a method of storing blood, the method including contacting red blood cells with the composition disclosed herewith. The composition comprises a nanoparticle that releases nitric oxide (NO). In one or more embodiments, a red blood cell or whole blood's lifespan is increased after contacted with the composition disclosed herein as compared to an untreated red blood cell or whole blood.

In one or more embodiments, treated red blood cell degradation is reduced as compared to an untreated red blood cell.

In one or more embodiments, the red blood cells are packed red blood cells or in whole blood.

In one or more embodiments, the method reduces toxicity associated with a blood transfusion. In one or more embodiments, the method enhances tissue perfusion. In one or more embodiments, the red blood cells were damaged by blood fractionation, a filtration procedure, or a pathogen inactivation treatment. In one or more embodiments, the blood storage and/or rejuvenating composition increases the transport capacity of red blood cells. In one embodiment, the composition is an additive solution.

In certain embodiments, the composition is administered to a human, animal, organ or tissue culture. In certain embodiments, the blood storage and/or rejuvenating composition is used for treatment of a chronic oxygen deficiency.

Also disclosed herein is a method of reducing infective organisms in stored blood using a nanoparticle that releases nitric oxide (NO). In certain embodiments, the infective organisms are drug resistant bacteria, virus, fungi, trypanosomes, or a combination thereof.

In certain embodiments, blood that has been treated has an increased functional capillary density (FCD) as compared to untreated blood.

In certain embodiments, whole blood that has been treated with the composition disclosed herein has a higher hematocrit as compared to untreated whole blood. In certain embodiments, the treated blood has a hematocrit transfusion rate of 13-15%, 15-20% relative to baseline, where aged blood's hematocrit transfusion rate is 10-12% relative to baseline. In certain embodiments, whole blood that has been treated has 90-99%, 99-100% of red blood cell remained in circulation 24 hours after transfusion.

In certain embodiments, the treated red blood cells or blood prevented the decrease in 2,3 DPG level, prevented the decrease in potassium levels, prevented rapid acidification, prevented increase levels of free hemoglobin (hemolysis), reduced the formation of microparticles in stored blood.

In certain embodiments, the treated red blood cell or blood maintains a higher amount of at least one of glucose, adenine, mannitol, and citrate. In certain embodiments, the treated red blood cell or blood has higher ATP and less pyruvate and less lactate as compared to untreated red blood cell or blood.

In certain embodiments, the treated red blood cell or blood maintains a higher amount of HK, GAPDH, G6PD, PK and PFK as compared to untreated red blood cell or blood.

In certain embodiments, the treated red blood cell or blood has increased plasma nitrite and/or plasma nitrate levels as compared to untreated red blood cell or blood.

In certain embodiments, the treated red blood cell has higher flexibility as compared to untreated red blood cell.

In certain embodiment, the red blood cells or blood is rejuvenated after contacted with the nanoparticles of the present disclosure as compared to red blood cells or blood that have not been contacted with the nanoparticles, said rejuvenated red blood cells or blood has one or more of the following characteristics: (i) increased oxygen transport capacity; (ii) decreased degradation; (iii) increased tissue perfusion; (iv) increased 2,3-DPG value; (v) increased functional capillary density (FCD); (vi) increased potassium levels; (vii) reduced rapid acidification; (viii) reduced hemolysis; (ix) reduced formation of free hemoglobin; (x) increased ATP; (xi) reduced pyruvate levels; (xii) reduced lactate levels; (xiii) increased nitrite and nitrate levels; and (xiv) increased flexibility.

In certain preferred embodiments, the method of rejuvenating blood includes: providing RBCs (e.g., packed RBCs or in whole blood) having a 2,3-DPG value lower than the value for freshly drawn blood; and mixing the RBCs with a blood storage and/or rejuvenating composition under conditions effective to increase the 2,3-DPG value, wherein the blood storage and/or rejuvenating composition includes a nanoparticle that releases nitric oxide (NO). In certain embodiments, conditions effective to increase the 2,3-DPG value include incubating the cells in the blood storage and/or rejuvenating composition at a temperature of 4° C. to 37° C. and in certain preferred embodiments at a temperature of room temperature. In certain embodiments, conditions effective to increase the 2,3-DPG value include incubating the cells in the blood storage and/or rejuvenating composition for a time of at least 10 minutes, in preferred embodiments for a time of 10 minutes to 48 hours, in certain preferred embodiments for a time of 10 minutes to 4 hours, and in other preferred embodiments for a time of 30 minutes to 2 hours. Exemplary conditions effective to increase the 2,3-DPG value include incubating the cells in the blood storage and/or rejuvenating composition at 37° C. for 10 minutes to four hours. Other exemplary conditions effective to increase the 2,3-DPG value include incubating the cells in the blood storage and/or rejuvenating composition at room temperature for 10 minutes to 24 hours, in some embodiments 10 minutes to 8 hours, and in some embodiments 10 minutes to four hours. In preferred embodiments, the blood storage and/or rejuvenating composition includes one or more of the blood storage and/or rejuvenating compositions described herein. Other methods of determining the freshness of blood and whether the blood is rejuvenated are known in the art include measuring the number of cells that stay in circulation after transfusion. FDA standards required that 75% of the transfused cells stay in circulation 24 hours after transfusion.

In certain preferred embodiments, the method of rejuvenating blood includes: providing RBCs (e.g., packed RBCs or in whole blood) having an ATP value lower than the value for freshly drawn blood; and mixing the RBCs with a blood storage and/or rejuvenating composition under conditions effective to increase the ATP value, wherein the blood storage and/or rejuvenating composition includes a nanoparticle that releases nitric oxide (NO). In certain embodiments, conditions effective to increase the ATP value include incubating the cells in the blood storage and/or rejuvenating composition at a temperature of 4° C. to 37° C., and in certain preferred embodiments at a temperature of room temperature. In certain embodiments, conditions effective to increase the ATP value include incubating the cells in the blood storage and/or rejuvenating composition for a time of at least 10 minutes, in preferred embodiments for a time of 10 minutes to 48 hours, in certain preferred embodiments for a time of 10 minutes to 4 hours, and in other preferred embodiments for a time of 30 minutes to 2 hours. Exemplary conditions effective to increase the ATP value include incubating the cells in the blood storage and/or rejuvenating composition at 37° C. for 10 minutes to four hours. Other exemplary conditions effective to increase the ATP value include incubating the cells in the blood storage and/or rejuvenating composition at room temperature for 10 minutes to 24 hours, in some embodiments 10 minutes to 8 hours, and in some embodiments 10 minutes to four hours. In preferred embodiments, the blood storage and/or rejuvenating composition includes one or more of the blood storage and/or rejuvenating compositions described herein.

In certain preferred embodiments, the method of rejuvenating blood includes: providing RBCs (e.g., packed RBCs or in whole blood) having a reduced glutathione value lower than the value for freshly drawn blood; and mixing the RBCs with a blood storage and/or rejuvenating composition under conditions effective to increase the reduced glutathione value, wherein the blood storage and/or rejuvenating composition includes a nanoparticle that releases nitric oxide (NO). In certain embodiments, conditions effective to increase the reduced glutathione value include incubating the cells in the blood storage and/or rejuvenating composition at a temperature of 4° C. to 37° C., and in certain preferred embodiments at a temperature of room temperature. In certain embodiments, conditions effective to increase the reduced glutathione value include incubating the cells in the blood storage and/or rejuvenating composition for a time of at least 10 minutes, in preferred embodiments for a time of 10 minutes to 48 hours, in certain preferred embodiments for a time of 10 minutes to 4 hours, and in other preferred embodiments for a time of 30 minutes to 2 hours. Exemplary conditions effective to increase the reduced glutathione value include incubating the cells in the blood storage and/or rejuvenating composition at 37° C. for 10 minutes to four hours. Other exemplary conditions effective to increase the reduced glutathione value include incubating the cells in the blood storage and/or rejuvenating composition at room temperature for 10 minutes to 24 hours, in some embodiments 10 minutes to 8 hours, and in some embodiments 10 minutes to four hours. In preferred embodiments, the blood storage and/or rejuvenating composition includes one or more of the blood storage and/or rejuvenating compositions described herein.

In certain preferred embodiments, the method of rejuvenating blood includes: providing RBCs (e.g., packed RBCs or in whole blood) having an oxygen dissociation P50 value lower than the value for freshly drawn blood; and mixing the RBCs with a blood storage and/or rejuvenating composition under conditions effective to increase the oxygen dissociation P50 value, wherein the blood storage and/or rejuvenating composition includes a nanoparticle that releases nitric oxide (NO). In certain embodiments, conditions effective to increase the oxygen dissociation P50 value include incubating the cells in the blood storage and/or rejuvenating composition at a temperature of 4° C. to 37° C., and in certain preferred embodiments at a temperature of room temperature. In certain embodiments, conditions effective to increase the oxygen dissociation P50 value include incubating the cells in the blood storage and/or rejuvenating composition for a time of at least 10 minutes, in preferred embodiments for a time of 10 minutes to 48 hours, in certain preferred embodiments for a time of 10 minutes to 4 hours, and in other preferred embodiments for a time of 30 minutes to 2 hours. Exemplary conditions effective to increase the oxygen dissociation P50 value include incubating the cells in the blood storage and/or rejuvenating composition at 37° C. for 10 minutes to four hours. Other exemplary conditions effective to increase the oxygen dissociation P50 value include incubating the cells in the blood storage and/or rejuvenating composition at room temperature for 10 minutes to 24 hours, in some embodiments 10 minutes to 8 hours, and in some embodiments 10 minutes to four hours. In preferred embodiments, the blood storage and/or rejuvenating composition includes one or more of the blood storage and/or rejuvenating compositions described herein.

In another aspect, the present disclosure further provides methods of improving the antioxidant defense of stored RBCs and whole blood.

In one embodiment, the method includes contacting RBCs with a blood storage and/or rejuvenating composition as described herein.

These and other aspects, features, and advantages can be appreciated from the accompanying description of certain embodiments and the accompanying drawing figures and claims.

### 4. DETAILED DESCRIPTION OF THE FIGURES

FIG. 1 shows the exchange transfusion protocol used to evaluate the hemodynamic responses to transfusion of stored blood.

FIG. 2 is a graphical representation of the mean arterial pressure over time after a blood transfusion of fresh blood, blood stored 21 days at 4° C. in citrate-phosphate-dextrose (CPD1), and blood stored 21 days at 4° C. in CPD1 while receiving NOnp every 48 hours.

FIGS. 3(A) and (B) are graphical representations over time of: (A) the microvascular blood flow of fresh blood, stored blood, and stored blood treated with NOnp; and (B) the functional capillary density (FCD) of fresh blood, stored blood, and stored blood treated with NOnp.

FIGS. 4(A)-(C) are graphical representations over time of: (A) hematocrit (HCT) of fresh blood, stored blood, and stored blood treated with NOnp; (B) the percentage of HCT transfused of fresh blood, stored blood, and stored blood treated with NOnp; and (C) the percentage of post-transfusion viability of fresh blood, stored blood, and stored blood treated with NOnp.

FIGS. 5(A)-(L) are graphical representations over time of: (A-C) the 2,3-DPG concentration; (D-F) potassium levels; (G-I) pH levels; and (J-L) levels of free hemoglobin. (A, D, G, J)-human blood; (B, E, H, K)-hamster blood; and (C, F, I, L)-rat blood.

FIGS. 6(A)-(C) are graphical representations over time of microparticle formation in: (A) human blood; (B) hamster blood; and (C) rat blood.

FIG. 7 shows the RBC glycolytic metabolic pathway.

FIGS. 8(A)-(D) are graphical representations over time of: (A) glucose; (B) mannitol; (C) adenine; and (D) citrate for NOnp, GSNO, DTPANO, and a control.

FIGS. 9(A)-(D) are graphical representations over time of: (A) glyceraldehyde 3-phosphate (G-3-P); (B) pyruvate; (C); lactate and (D) ATP for NOnp, GSNO, DTPANO, and a control.

FIGS. 10(A)-(E) are graphical representations over time of: (A) hexokinase (HK); (B) glyceraldehyde 3-phosphate dehydrogenase (GAPDH); (C) glucose-6-phosphate dehydrogenase (G6PD; (D) pyruvate kinase (PK); and (E) phosphofructokinase (PFK) for NOnp, GSNO, DTPANO, and a control.

FIGS. 11(A)-(L) are graphical representations over time of: (A-C) the 2,3-DPG concentration; (D-F) potassium levels; (G-I) pH levels; and (J-L) levels of free hemoglobin for blood treated with NOnp, GSNO, DTPANO, and a control. (A, D, G, J)-Human RBC. (B, E, H, K)-Hamster RBC. (C, F, I, L)-Rat RBC.

FIGS. 12(A)-(C) are graphical representations over time of microparticle formation in blood treated with NOnp, GSNO, DTPANO, and a control for: (A) human blood; (B) hamster blood; and (C) rat blood.

FIG. 13 is a graphical representation over time of the percentage of methemoglobin (MetHb) in blood treated with NOnp, GSNO, DTPANO, and a control.

FIG. 14 is a graphical representation over time of nitrite buildup in blood treated with NOnp, GSNO, DTPANO, and a control.

FIG. 15 is a graphical representation over time of nitrate buildup as a function of additive added to stored blood in blood treated with NOnp, GSNO, DTPANO, and a control.

FIGS. 16(A)-(D) are graphical representations over time of the mechanical properties of RBC and treated RBCs during storage after: (A) 1 week; (B) 3 weeks; (C) 5 weeks; and (D) 6 weeks.

### 4.1 DEFINITIONS

When referring to the compounds provided herein, the following terms have the following meanings unless otherwise indicated.

As used herein, the terms “RBC” and “blood” are interchangeable. Such terms can also refer to specific cells.

As used herein, the term “additives” may refer to stored RBCs treated with NO releasing nanoparticles, nitrosothiol derivatives, dinitrogen trioxide, diazeniumdiolate (NONOates) or other NO releasing organic molecules.

As used herein, the terms “DPTANO” and “DPTA” are interchangeable.

As used herein, the terms “supplementation” and “treatment” are interchangeable regarding the addition of nitric oxide releasing nanoparticles to stored blood.

As used herein, the term “whole blood” refer to blood drawn from the body from which none of the components, such as plasma or platelets, has been removed.

### 5. DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter. It is to be understood that particular features, structures, or characteristics described may be combined in various ways in one or more implementations.

In order to meet the need for a mechanism or approach to extending the lifespan of stored blood, disclosed herein are additives that are capable of sustained release of NO. Provided herein is an additive that uses hydrogel based nanoparticles for releasing NO into stored blood (NOnp). Hydrogel-based nanoparticle platforms are capable of releasing internally generated NO at biologically significant levels over sustained time periods. By releasing NO into stored blood, the oxygen-delivering capabilities of RBCs are extended. This is achieved via hydrogel nanoparticles carrying NO or other bioactive forms of NO, including nitrosothiols, nitrofatty acids, dinitrogen trioxide, or diazeniumdiolates (NONOates). Nitrosothiol containing molecules that can be encapsulated within the nanoparticle include, but are not limited to, S-nitroso-N-acetyl cysteine (NAC) and/or S-nitroso-captopril. NONOates can release NO spontaneously and contain NO complexed with nucleophiles, allowing for controllable rates of NO release via various parameters including pH, temperature and the nature of the nucleophile with which the NO is complexed or conjugated.

Methods of producing NO releasing nanoparticles (NO-np) have been described in, for example, U.S. Patent Application Publication No. 2014/0220138 and PCT International Publication No. WO 2013/169538, the contents of which are herein incorporated by reference.

For example, NO-np can be formed of nitric oxide encapsulated in a matrix of chitosan, polyethylene glycol (PEG) and/or polyvinyl alcohol (PVA), and tetra-methoxy-ortho-silicate (TMOS) or tetra-ethoxy-ortho-silicate (TEOS). Another composition for releasing nitric oxide (NO) is formed of nitric oxide encapsulated in a matrix of trehalose, and non-reducing sugar or starch. The composition can further include nitrite, reducing sugar, and/or chitosan. Another composition for releasing nitric oxide (NO) includes nitrite; reducing sugar; chitosan; polyethylene glycol (PEG) and/or polyvinyl alcohol (PVA); tetra-methoxy-ortho-silicate (TMOS) or tetra-ethoxy-ortho-silicate (TEOS); and nitric oxide encapsulated in a matrix of chitosan, PEG and TMOS. Another composition for releasing nitric oxide (NO) includes nitrite; reducing sugar; chitosan; trehalose; a non-reducing sugar or starch; and nitric oxide encapsulated in a matrix of trehalose and the non-reducing sugar or starch. Another composition includes nitrite, reducing sugar, chitosan, polyethylene glycol (PEG) and tetra-methoxy-ortho-silicate (TMOS) or tetra-ethoxy-ortho-silicate (TEOS), and a composition comprising nitrite, reducing sugar, chitosan, trehalose, and non-reducing sugar or starch. Nitric oxide is released when the composition is exposed to an aqueous environment.

The nanoparticles can be formed of, for example, silica, chitosan, polyethylene glycol, nitrite, glucose, hydrolyzed tetramethoxysilane (TMOS) and hydrolyzed 3-mercaptopropyltrimethoxysilane (MPTS). The nanoparticles can also be formed of, for example, silica, chitosan, polyethylene glycol, nitrite, glucose, hydrolyzed tetramethoxysilane (TMOS) and S-nitroso-N-acetyl cysteine (NAC) and/or S-nitroso-captopril.

NOnp can include a silane in addition to TMOS or TEOS. The additional silane can be chosen, for example, to either alter the internal environment of the resulting particles with respect to properties such as hydrophobicity and polarity or to introduce reactive groups (e.g. amino, carboxyl, sulfhydryl) that allow the covalent attachment of additional molecules to the particles. The additional silane can be, for example, a hydrophobic silane, such as, for example, trimethoxyalkyl isopropyl silane, trimethoxyalkyl butyl silane or trimethoxyalkyl fluoropropyl silane.

As mentioned above, NOnp can also be formed of the angiotensin converting enzyme (ACE) inhibitor, captopril. Captopril contains a thiol group that can be nitrosylated to form S-nitroso-captopril (captopril-SNO). In this embodiment, NO is generated and released from the nanoparticle, it is bound up by the captopril sulfhydryl moiety, providing a long lasting NO-donating technology. At the nanoscale, this technology has an increased ability to interact with its intended target and exert its biological impact over an extended period of time.

In at least one embodiment, the NOnp can be a paramagnetic hydrogel hybrid nanoparticle, which can be more uniform with respect to size distribution and more compact with respect to the internal polymeric network, which can result in a slower release profile. This embodiment can also include alcohol to reduce water content and thereby enhance the hydrogen bonding network due to water of the nanoparticles. Toxicity due to the use of alcohol is not an issue because of the lyophilization process, which removes all volatile liquids including free water and alcohol. Further, amine groups can also be incorporated into the polymeric network through the addition of amine-containing silanes (e.g., aminopropyltrimethoxysilane) with TMOS or TEOS, which are used to generate the hydrogel polymeric network. The addition of amine-containing silanes can accelerate the polymerization process, contribute to a tighter internal hydrogen bonding network, and help in PEG conjugation on the surface of the nanoparticles as a means of extending systemic circulation time and increasing the probability of localization at a site with leaky vasculature.

Other modifications to the paramagnetic hydrogel hybrid NOnp can include the introduction of oleic acid or conjugated linoleic acid, and/or other unsaturated fatty acids. When these are included in the NOnp, the resulting nanoparticles contain nitro fatty acids, which are highly anti-inflammatory and potentially chemotherapeutic. Alternatively, nitro fatty acids can be prepared and then incorporated into the recipe for generating the nanoparticles. The introduction of oleic acid or conjugated linoleic acid, and/or other unsaturated fatty acids into the NOnp provides a lipophilic interior to the nanoparticles that will enhance loading of lipophilic deliverables.

Another modification to the paramagnetic hydrogel hybrid NOnp include doping the TMOS or TEOS with trimethoxy silane derivates that at their fourth conjugation site (e.g., Si(OCH3)3(X)) contains derivatives such as a thiol containing side chain, a lipid containing side chain, a PEG containing side chain, or an alkyl side chain of variable length. Other additives can also be added to the paramagnetic NOnp to enhance the physical properties of the paramagnetic NOnps, such as polyvinyl alcohols.

One method for preparing a paramagnetic hydrogel hybrid NOnp comprises, for example: (a) hydrolyzing TetramethylOrthosilicate (TMOS); (b) mixing the sol-gel components; (c) lyophilizing the sol-gel; (d) ball-milling the lyophilized sol-gel particles; and (e) PEGylating of the nanoparticles. Specifically, 5 ml of TMOS, 600 μl of deioinized water, and 560 μl of 2 mM hydrochloric acid are added to a small vial. The contents of the vial are then sonicated approximately 20-30 minutes to get a clear solution and placed on ice. A separate solution of 800 mg of Gadolinium chloride hexahydrate and 200 mg of europium chloride hexahydrate are then solubilized in 6-8 ml of deionized water followed by sequential addition and mixing of 1 ml of PEG-200, 1 ml (1 mg/ml) of either chitosan or water soluble chitosan (depending on the application and usage), and 30 ml of methanol. The resulting mixture is then vortexed thoroughly. Then, 2 ml of the previously hydrolyzed TMOS is added to the solution along with approximately 75-150 μl of 3-aminopropyltrimethoxysilane followed by constant stirring. 4 to 6 ml of ammonium hydroxide is added to the above admixture to form gel followed by vigorous vortexing until complete gelation. The hydroxide creates paramagnetic gadolinium/europium hydroxide that is distributed throughout the resulting hydrogel. The hydroxide also accelerates polymerization which favors small polymers leading to smaller nanoparticles. The resulting gelled material is then lyophilized for 24-48 hours, which removes all volatile component including the methanol. Following lyophilization, the dry material is ball milled at 150 rpm for 8 hours. The resulting material is a very fine white powder. Finally, PEGylation of the paramagnetic nanoparticles is achieved by mixing a suspension of the nanoparticles with an amine binding PEG. Similarly, peptides can be bound to the surface via reaction with the amines on the surface of the nanoparticle. This process can be carried out in water, alcohol or DMSO depending on the nature of the deliverable. Water will initiate release for nitric oxide, and thus the PEGylation needs to be carried out in DMSO which does not result in release of NO. Once the reaction is complete, the PEGylated nanoparticles can be redried and then stored as a dry powder. In an alternative embodiment, thiols can be incorporated into the nanoparticle by using thiol-containing silanes in a manner similar to the process of introducing amines.

Another method for preparing a paramagnetic hydrogel hybrid NOnp comprises, for example: (a) hydrolyzing TMOS; (b) mixing the sol-gel components; (c) washing the sol-gel; (d) lyophilizing the sol-gel; and (e) ball-milling the sol-gel particles. Specifically, 5 ml of TMOS, 600 μl of deioinized water, and 560 μl of 2 mM hydrochloric acid are added to a small vial. The contents of the vial are then sonicated approximately 20-30 minutes to get a clear solution and placed on ice. 28 ml of methanol, 1 mL of polyvinyl alcohol (PVA) from stock solution (10 mg/mL in deionized water), 2 ml of 300 mM Tris (HCl) buffer at pH 7.5, 1 ml of glycerol, 4 ml of chitosan (1 mg/ml), and 2.76 g of sodium nitrite are then dissolved in the mixture in the above order, and vortexed thoroughly. Then, 4 ml of previously hydrolyzed TMOS is added to the tube, and the contents are vortexed for about two minutes. The tube is allowed to sit undisturbed for gelation. It forms gel in 5 to 10 min. The resulting sol-gel is crushed and deionized water is added until the tube is nearly full. The contents are then vortexed until the mixture is relatively homogeneous. Then, the mixture is centrifuged at 6,000 rpm for 25 minutes, and the supernatant is removed. The gel is then lyophilized for 24-48 hrs. Finally, the resulting particles were ball milled at 150 rpm for 3 hours.

A method for preparing a paramagnetic hydrogel hybrid NOnp with added conjugated linoleic acid comprises, for example: (a) hydrolyzing TMOS; (b) mixing the sol-gel components; (c) lyophilizing the sol-gel; and (d) ball-milling the sol-gel particles. Specifically, 5 ml of TMOS, 600 μl of deioinized water, and 560 μl of 2 mM hydrochloric acid are added to a small vial. The contents of the vial are then sonicated approximately 20-30 minutes to get a clear solution and placed on ice. 1 ml of conjugated linoleic acid (sigma) in DMSO (1:19 v/v ratio in stock), 1.49 g of sodium nitrite (dissolved in 4 ml of PBS buffer at pH 7.5), 1 ml of PEG-200, 800 μl of chitosan (1 mg/ml), and 28 ml of methanol are then mixed in the above order and vortexed thoroughly. Then, 2 ml of previously hydrolyzed TMOS is added to the solution, and 50-75 μl of 3-aminopropyltrimethoxysilane is added followed by vigorous vortexing until complete gelation. The gel was then lyophilized for 24-48 hrs, and the resulting particles were ball milled at 150 rpm for 8 hours.

One method for preparing NOnp comprises, for example: (a) admixing nitrite, reducing sugar, chitosan, polyethylene glycol (PEG) and/or polyvinyl alcohol (PVA), and tetra-methoxy-ortho-silicate (TMOS) or tetra-ethoxy-ortho-silicate (TEOS); (b) drying the mixture of step (a) to produce a gel; and (c) heating the gel until the gel is reduced to a powdery solid. The nitrite is reduced to nitric oxide by the reducing sugar, and nitric oxide is encapsulated in the powdery solid. The encapsulated nitric oxide is released when the composition is exposed to an aqueous environment. The solid of step (c) can be ground to produce particles of a desired size. Preferably, the gel is heated in step (c) to a temperature of 55-70° C., more preferably to about 60° C. Preferably, the gel is heated in step (c) for 24-28 hours. Another method for preparing a composition for releasing nitric oxide (NO) comprises: (a) admixing nitrite, reducing sugar, chitosan, trehalose, and non-reducing sugar or starch; (b) drying the mixture of step (a) to produce a film; and (c) heating the film to form a glassy film. The nitrite is reduced to nitric oxide by the reducing sugar, and nitric oxide is encapsulated in the glassy film. The encapsulated nitric oxide is released when the composition is exposed to an aqueous environment. Preferably, the film is heated in step (c) to a temperature of 55-70° C., more preferably to about 65° C. Preferably, the film is heated in step (c) for about 45 minutes. Preferably, the nitrite is a monovalent or divalent cation salt of nitrite, including for example, one or more of sodium nitrite, calcium nitrite, potassium nitrite, and magnesium nitrite. Preferably, the concentration of nitrite in the composition is 20 nM to about 1 M. The gel can also be lyophilized to produce a particulate material. Alternatively, the mixture may be spray dried to produce a particulate material.

As used herein, a “reducing sugar” is a sugar that has a reactive aldehyde or ketone group. The reducing sugar is used to reduce nitrite to nitric oxide. All simple sugars are reducing sugars. Sucrose, a common sugar, is not a reducing sugar. Examples of reducing sugars include one or more of glucose, tagatose, galactose, ribose, fructose, lactose, arabinose, maltose, and maltotriose. Preferably, the concentration of reducing sugar in the composition is 20 mg-100 mg of reducing sugar/ml of composition.

Preferably, the chitosan is at least 50% deacetylated. More preferably, the chitosan is at least 80% deacetylated. Most preferably, the chitosan is at least 85% deacetylated. Preferably, the concentration of chitosan in the composition is 0.05 g-1 g chitosan/100 ml of composition (dry weight).

Preferably, the concentration of TMOS or TEOS in the composition is 0.5 ml-5 ml of TMOS or TEOS/24 ml of composition (dry weight).

Preferably, the polyethylene glycol (PEG) has a molecular weight of 200 to 20,000 Daltons, more preferably 200-10,000 Daltons, and most preferably 200-5,000 Daltons. In different embodiments, the PEG can have a molecular weight of, for example, 200-400 Daltons or 3,000-5,000 Daltons. A preferred polyethylene glycol has a molecular weight of 400 Daltons. PEGs of various molecular weights, conjugated to various groups, can be obtained commercially (see, for example, Nektar Therapeutics, Huntsville, Ala.). Preferably, the concentration of polyethylene glycol (PEG) in the composition is 1-5 ml of PEG/24 ml of composition (dry weight).

The nanoparticles can be formed in sizes having a diameter in dry form, for example, of 10 nm to 1,000 μm, preferably 10 nm to 100 μm, or 10 nm to 1 μm, or 10 nm to 500 nm, or 10 nm to 100 nm. Preferably, the nanoparticles have an average diameter of less than about 500 nm, more preferably less than about 250 nm, and most preferably less than about 150 nm.

Preferably, NOnp are nontoxic, nonimmunogenic and biodegradable.

Also disclosed herein is a method of preparing nanoparticles comprising S-nitrosothiol (SNO) groups covalently bonded to the nanoparticles, the method comprising: a) providing a buffer solution comprising chitosan, polyethylene glycol, nitrite, glucose, and hydrolyzed 3-mercaptopropyltrimethoxysilane (MPTS); b) adding TMOS to the buffer solution to produce a sol-gel; and c) lyophilizing and ball milling the sol-gel to produce nanoparticles of a desired size.

Provided herein is a method of preparing nanoparticles including a S-nitrosothiol containing molecule encapsulated within the nanoparticle, the method including: a) providing a buffer solution comprising chitosan, polyethylene glycol, nitrite, glucose, and a S-nitrosothiol containing molecule; b) adding TMOS to the buffer solution to produce a sol-gel; and lyophilizing and ball milling the sol-gel to produce nanoparticles of a desired size. The S-nitrosothiol containing molecule encapsulated within the nanoparticle can be, for example, S-nitroso-N-acetyl cysteine (NAC-SNO) and/or S-nitroso-captopril (captopril-SNO).

Preferably MPTS is hydrolyzed with HCl by sonication on an ice-bath. Preferably, TMOS is hydrolyzed with HCL by sonication on an ice-bath.

In accordance with one or more embodiments, the nanoparticles encapsulating S-nitrosothiol-containing molecules are easily produced in small or bulk scale for commercial purposes and are relatively inexpensive. Furthermore, the NO or S-nitrosothiols nanoparticles are stable over a wide range of temperatures, when maintained in a dry and sealed environment. There has been no evidence of any toxicity in extensive animal studies, including in large mammal studies using pigs. The unique aspects of this formulation include: i) long circulation time; ii) the capability for slow sustained release of therapeutically effective levels of nitric oxide within the vasculature; and iii) a platform that is amenable to modifications for fine-tuning of delivery rates and circulation time. Additionally, the platform accommodates the delivery of S-nitrosothiols (e.g., NACSNO) and Captopril-SNO. S-nitrosothiols can be viewed as long lived bioactive forms of nitric oxide. Systemic studies using nanoparticles containing NAC-SNO also support NO-like efficacy in the vasculature. Treatment and administration can proceed by any suitable route, including by introducing the nitric oxide releasing nanoparticles into an IV infusion or transmucosal systemic delivery via sublingual gel or rectal suppository, or combinations of these delivery methods.

Other embodiments include mixing the NOnp with glutathione or other small thiol containing molecules, PEGylating the surface of the NOnp to minimize aggregation, Use of powders derived from nitrite containing trehalose/sugar mixtures that provide for thermal reduction of nitrite to NO. These glassy powders will release NO in a burst mode as they melt when added to an aqueous environment. These rapid release materials can be used to rapidly sterilize the stored blood.

Further provided herein is a pharmaceutical composition comprising any of the nanoparticles disclosed herein and a pharmaceutically acceptable carrier.

The nanoparticles described herein can be delivered to a subject by a variety of topical or systemic routes of delivery, including but not limited to percutaneous, inhalation, oral, local injection and intravenous introduction. The nanoparticles can be incorporated, for example, in a cream, ointment, transdermal patch, implantable biomedical device or scrub.

The compositions described herein can be used, for example, in a method of storing blood. In certain embodiments, the method includes contacting RBCs (e.g., packed RBCs or in whole blood) with a blood storage and/or rejuvenating composition as described herein.

The compositions described herein can be used, for example, in a method of rejuvenating blood. In certain embodiments, the method includes contacting RBCs (e.g., packed RBCs or in whole blood) with a blood storage and/or rejuvenating composition as described herein.

In some embodiments, the blood storage and/or rejuvenating compositions disclosed herein can be in the form of additive solutions that can be added to RBCs upon collection of the whole blood; to RBCs before, during, and/or after the plasma is removed; and/or to packed RBCs before, during, and/or after storage.

Stored blood also acidifies intracellularly over time. This reduces individual red blood cell acute oxygen binding characteristics. As disclosed herein, the composition in some embodiments increases the oxygen transport capacity of red blood cells. This regenerates the oxygen binding characteristics of the red blood cells. This increase blood oxygen delivery capacity of the red blood cells by preserving red blood cell mechanics and deformability. This preserves red blood cells ability to deform in capillaries delivering oxygen to tissues. The composition may also be used to treat chronic oxygen deficiencies in tissues by supplying hyperbaric oxygen. NOnp treated blood may be used as a temporary support for the endogenous oxygen transport system, which offers an alternative to conventional methods to combating chronic oxygen deficiencies, such as vessel dilators. In some embodiments, the composition may treat an oxygen deficiency in the case of a heavy loss of blood. In certain embodiments, the composition may be combined with a plasma expander to permit a loss of blood to be treated by a physician who may coordinate administration of oxygen carriers as well as liquid volume with the requirements of an individual patient.

Use of NOnp in a sol-gel/glass hybrid system allows for a source of low but sustained level of NO in RBCs. Controlled, sustained release of NO may achieved from a stable, dry powder. This powder may be comprised of nanoparticles for releasing NO. The capacity of these particles to retain and gradually release NO arises from their having combined features of both glassy matrices and hydrogels. This feature allows both for the generation of NO through the thermal reduction of added nitrite by glucose and for the retention of the generated NO within the dry particles. Exposure of these robust biocompatible nanoparticles to moisture initiates the sustained release of the trapped NO over extended time periods as determined both fluorimetrically and amperometrically. The slow sustained release is in contrast to the much faster release pattern associated with the hydration-initialed NO release in powders derived from glassy matrices. These glasses are prepared using trehalose and sucrose doped with either glucose or tagatose as the source of thermal electrons needed to convert nitrite to NO. Significantly, the release profiles for the NO in the hydrogel/glass composite materials are found to be an easily tuned parameter that is modulated through the specific additives used in preparing the hydrogel/glass composites.

Upon exposure to an aqueous environment, NOnp begins releasing therapeutic levels of NO over several hours to days. Treatment with NOnp further slows RBC degradation, including rates of hemolysis and reduction in microparticle formation, and enhances RBC circulation time when stored RBCs are infused into humans or animals. The method is viable for extending RBC and whole blood shelf-life.

In one embodiment, the nanoparticle is stored in a non-aqueous solution. In certain embodiment, the nanoparticle is stored in a buffer suitable for administration in human. In certain embodiment, the nanoparticle is stored in plasma. In certain embodiment, the nanoparticle is stored in the absence of aqueous solution. In certain embodiment, the nanoparticle is stored in the absence of water.

Further, the additives provided herein reduce or eliminate the toxicity associated with blood transfusions, which in turn reduces costs and improves safety associated with blood transfusions. NOnp treatment of blood as disclosed herein increases 2,3-DPG concentration, which decreases oxygen affinity and increases oxygen delivery to affected tissue after transfusion. This helps maintain cellular energetics and decreases cell fragility and increases deformability, thereby improving flow through capillaries. The infusion of NOnps either intraperitoneally (IP) or intravenously (IV) is also anti-inflammatory, induces vasodilatation, and enhances tissue perfusion by enhancing functional capillary density. NOnp supplemented blood also counters the consequences of NO scavenging by acellular hemoglobin. The net result is a decrease in storage lesions and greater oxygen delivery to affected tissue following transfusion. Furthermore, NOnp can prevent the inflammatory cascade associated with hemorrhagic shock. In other embodiments, where the nanoparticles release the S-nitrosothiol derivative of N-acetylcysteine (NAC), substantially the same results are achieved.

NO-np Supplementation:

NO releasing nanoparticles were added to the blood at 10 mg per 125 mL of whole blood. Stored blood was treated with the nanoparticles once every 48 hours at the above described dosing over a period of 21 days for the in vivo transfusion studies. The storage lesion studies were extended to a period of 6 weeks.

Stored blood treated with the nanoparticles is effective in reducing hemolysis and membrane loss during storage. The present disclosure provides a collection system. In certain embodiments, the collection system is polyvinyl ester, PVC or bag plasticizer. In certain embodiments, the collection system comprises a bag suitable for storing blood or plasma. In certain embodiments, the collection system comprises a primary bag and a satellite bag. In certain embodiments, the collection system comprises one or more anticoagulants. In certain embodiment, the anticoagulant is citrate phosphate dextrose. In certain embodiment, the collection system comprises a satellite bag comprising a storage solution and the nanoparticles. In certain embodiments, the storage solution comprises saline, adenine, glucose, mannitol or a combination thereof. In certain embodiments, the bag comprises nanoparticles. In certain embodiments, the bag further comprises membrane stabilizers, such as mannitol, citrate, bicarbonate buffering or a combination thereof. In certain embodiments, the collection system reduces leukocyte contamination in blood components. The supplementation of nanoparticles rejuvenate the stored blood.

In certain embodiment, the collection system comprises a main bag connected to two bags, bag 1 and bag 2. Bag 1 comprises a solution comprising saline, adenine, glucose, mannitol or a combination thereof. Bag 2 comprises NO nanoparticles. In certain embodiment, blood is collected in bag 1 that optionally comprises an anticoagulant, which is connected to bag 2 to receive the additives for long term storage. In one embodiment, the additive is the NO nanoparticles that are disclosed herein. There is world-wide demand for leuko-reduced blood, so the collection system can include leuko reduction filters. In certain embodiment, the filter is between bag 1 and bag 2.

In addition, the additives provided herein are effective in preventing stored blood contamination with infectious agents. NOnp of the present disclosure is highly effective antimicrobials for a very wide range of infective organisms including drug resistant strains (ESKAPE organisms), fungi and trypanosomes.

RBC hypothermic storage has led to the success of up to 42 day storage of RBCs. However, some current storage solutions do not prevent the time dependent oxidative assault on the red cells that lead to the formation of reactive oxygen species, attachment of denatured hemoglobin to membrane phospholipids, and the release of hemoglobin containing membrane microvesicles throughout storage.

In one or more embodiments, the blood storage and/or rejuvenating compositions disclosed herein have the additional benefit of preserving and enhancing the antioxidant defense of the stored red cells, thereby reducing the storage lesion. It is believed that the storage solution will positively impact blood banking and transfusion techniques by providing a composition that minimizes the effect of RBC storage lesions and improves functionality of stored RBCs. In one or more embodiments the blood storage and/or rejuvenating compositions disclosed herein maintain the GSH levels of the hypothermic stored RBCs, which in turn preserve the antioxidant activity in stored blood. In one or more embodiments, the blood storage and/or rejuvenating compositions disclosed herein include D-Ribose in a solution, which can allow for bypassing the rate limiting steps of the pentose phosphate pathway of glucose metabolism to stimulate PRPP synthesis.

In one embodiment, the composition comprises nanoparticles and one or more of the following: Dextrose (in the range of 50-70 mM, 70-90 mM, 90-100 mM, 100-120 mM or 120-150 mM), Adenine (0.1-0.5 mM, 0.5-1 mM, 1-2 mM or 2-3 mM), Monobasic sodium phosphate (0.1-0.5 mM, 0.5-1 mM, 1-5 mM, 5-10 mM, 10-15 mM, 15-20 mM or 20-25 mM), Mannitol (0.1-0.5 mM, 0.5-1 mM, 1-5 mM, 5-10 mM, 10-15 mM, 15-20 mM, 20-25 mM, 25-50 mM, 50-80 mM, 80-100 mM), Sodium citrate (0.5-1 mM, 1-5 mM, 5-10 mM, 10-15 mM, 15-20 mM or 20-25 mM), Citric acid (2.0-2.5 mM), glucose (0.5-1 mM, 1-5 mM, 5-10 mM, 10-15 mM, 15-20 mM or 20-25 mM or 25-40 mM).

Provided herein is a composition comprising a nanoparticle described herein. The composition further comprises a non-aqueous solution. In certain embodiments, the composition further comprises a buffer suitable for administration in human. In certain embodiments, the composition further comprises plasma. In certain embodiments, the composition further comprises red blood cells. In certain embodiments, the composition does not contain an aqueous solution. In certain embodiments, the composition does not contain water.

In certain embodiments, the concentration of nanoparticles in a composition is 0.01-0.02, 0.02-0.05, 0.05-0.08, 0.08-0.1, 0.1-0.12, 0.12-0.15, 0.15-0.18, 0.18-0.2, 0.2-0.23, 0.23-0.25 mg/ml. In certain embodiment, the concentration of nanoparticles in a composition is 0.08-0.12 mg/ml. In certain embodiment, the concentration of nanoparticles in a composition is 0.05-0.1 mg/ml. In one embodiment, the concentration of nanoparticles is 0.8 mg/ml. In one embodiment, the composition comprises 10 mg of nanoparticle per 125 ml of whole blood.

In one embodiment, NO releasing nanoparticles were added to the blood at 10 mg per 125 mL of whole blood. Stored blood was treated with the nanoparticles once every 48 hours at the above described dosing over a period of 21 days for the in vivo transfusion studies. The storage lesion studies were extended to a period of 6 weeks.

Provided herein is a kit comprising the nanoparticle described herein. The kit further comprises a non-aqueous solution. In certain embodiments, the kit further comprises a buffer suitable for administration in human. In certain embodiments, the kit further comprises plasma. In certain embodiments, the kit further comprises red blood cells. In certain embodiments, the kit does not contain an aqueous solution. In certain embodiments, the kit does not contain water. In certain embodiments, the kit is a device. In certain embodiments, the device is a bag or a pouch.

The nanoparticles and method disclosed herein will be better understood from the experimental examples, which follow. However, one skill in the art will readily appreciate that the specific methods and results discussed are merely illustrative of the invention as described more fully in the claims that follow thereafter.

### 6. EXAMPLES

The following examples refer to the efficacy of additives in accordance with one or more embodiments of the present application.

### 6.1. EFFICACY OF NOnp WITH RESPECT TO EXTENDING RBC SHELF LIFE, REDUCING TOXICITY, AND REDUCING CONTAMINATION IN VIVO

This study was performed in Sprague-Dawley rats weighing 176 to 222 g. Experiments were approved by the University of California San Diego, Institutional Animal Care and Use Committee, and conducted according to the Guide for the Care and Use of Laboratory Animals (US National Research Council, 2010). Briefly, rats were anesthetized intraperitoneally (IP) with 60 mg/kg of pentobarbital sodium and additional anesthesia was administered throughout the experiment as needed. Each animal's left femoral artery was catheterized for blood withdrawals and pressure measurements. The right femoral vein was also catheterized for fluid and anesthesia administration. Each animal was then positioned on a stage with temperature control where the catheter was removed and the incisions closed. The next day, each animal's right femoral artery was catheterized for blood withdrawals and pressure measurements.

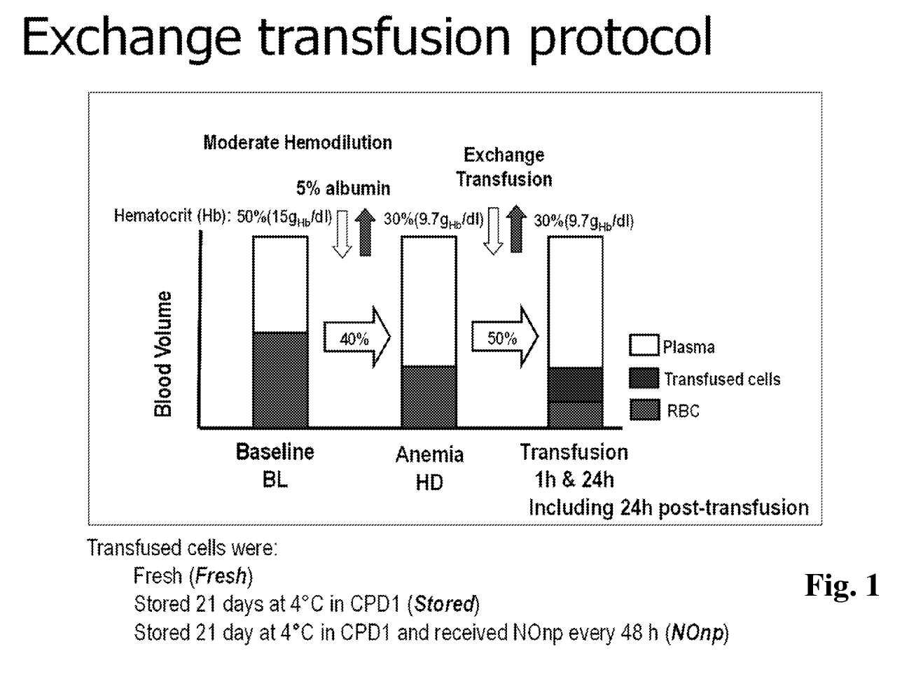

FIG. 1 visually depicts the exchange transfusion protocol used to evaluate the hemodynamic responses to transfusion of stored blood. An isovolemic hemodilution to 30% Hct (about 40% blood volume (BV), estimated as 6% of body weight) was performed to mimic anemic conditions when red cells are transfused. Hemodilution was accomplished by concurrent withdrawal of blood from the arterial catheter and simultaneous infusion of 5 weight % human serum albumin (HSA) via the venous catheter. Exchange transfused animals were randomly divided into two experimental groups, and exchange-transfused by 50% of their estimated BV either with 21 days old rat's stored blood with and without NO supplementation using NOnp (1 mg/dL every 48 hours). Both stored blood with and without NO supplementation were adjusted to 30% Hct. Exchange transfusion was performed at a rate of 0.3 ml/min, to prevent volume shifts. Systemic and microhemodynamic measurements were obtained at baseline (BL), 20 min after the exchange transfusion (Day 0) and the next day (24 hours later).

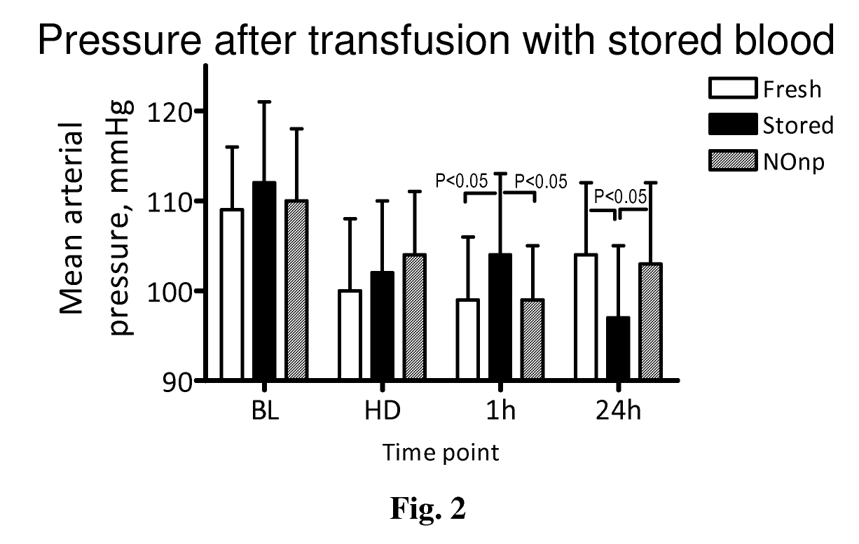

Mean arterial pressure (MAP) and heart rate (HR) were measured from the carotid artery catheter as shown in FIG. 2. Arterial blood gases (PO₂ and PCO₂) were measured from arterial blood collected into heparinized capillaries and immediately analyzed. Hemoglobin (Hb) was determined spectrophotometrically from a drop of blood. Hct was measured by centrifugation of glass capillaries filled with blood. Changes in Hct over 24 hour were used to access red cell survivability after transfusion.

FIG. 2 shows the MAP over times for fresh blood, and 21 days old rat's stored blood with and without NO supplementation using NOnp. Transfusion of untreated stored blood increased blood pressure quickly before falling over time, whereas transfusion of stored blood treated with NOnp was not significantly different from fresh RBCs. The MAP of the NOnp treated stored blood was substantially equivalent to the MAP of fresh blood at BL (approximately 110 mmHg), after 1 hour (approximately 98 mmHg), and after 24 hours (approximately 105 mmHg). The MAP of untreated stored blood was not substantially equivalent at these time periods, being approximately 110 to 120 mmHg at BL, 100-120 mmHg at 1 hour, and 90-100 mmHg at 24 hours.

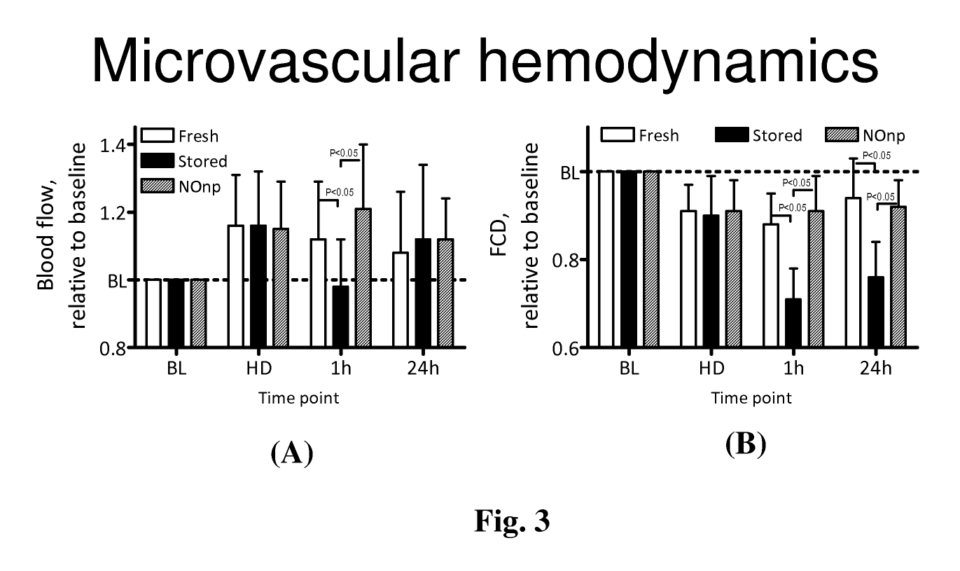

In this example, transfused blood treated with NOnp correlated with reduced morbidity/mortality associated with vascular events, such as hemorrhage or other acute inflammatory episodes. FIG. 3(A) describes the microvascular hemodynamics for fresh blood, and 21 days old rat's stored blood with and without NO supplementation using NOnp. In this example, the blood flow and functional capillary density (FCD) of a transfusion of stored blood treated with NOnp was not significantly different from fresh RBCs over time. NOnp treated blood flowed higher relative to a baseline measure than both fresh and stored blood after a 1 hour period and flowed substantially the same as both fresh and stored blood after 24 hours. In some embodiments, after a period of 1 hour, NOnp treated blood flowed 1.00-1.05, 1.05-1.10, 1.10-1.15, 1.15-1.20, 1.20-1.25, 1.25-1.30, 1.30-1.35, 1.35-1.40, 1.40-1.45, or 1.45-1.50 fold better than a baseline measurement. In some embodiments, after a period of 24 hours, NOnp treated blood flowed 1.00-1.05, 1.05-1.10, 1.10-1.15, 1.15-1.20, 1.20-1.25, 1.25-1.30, 1.30-1.35, 1.35-1.40, 1.40-1.45, or 1.45-1.50 fold better than a baseline measurement.

The FCD of transfused blood is also a good indicator of transfusion efficacy and reduced morbidity. FCD indicates the quality of tissue perfusion, which effectively is a measurement of how well blood passes through organs. Over time, the FCD of transfused blood declines due to the aging and hemolysis of RBCs. Hemolysis releases hemoglobin which results in a pro-inflammatory effect. Minimizing this effect thereby sustains FCD. FIG. 3(B) compares the FCD of fresh blood, and 21 days old rat's stored blood with and without NO supplementation using NOnp. In this example, after 24 hours, the FCD of stored blood was approximately 0.7 relative to baseline, while the FCD of NOnp treated blood remained at approximately 0.9 relative to baseline. NOnp treated blood remained in circulation more effectively than RBCs of 21 days old stored blood, whose RBCs were taken out of circulation in greater numbers by the spleen and liver.

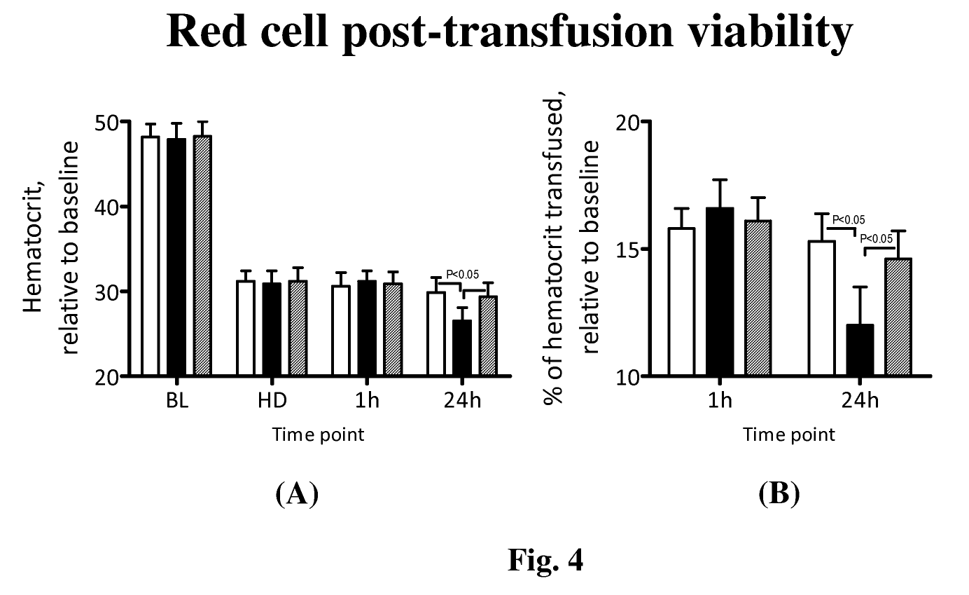

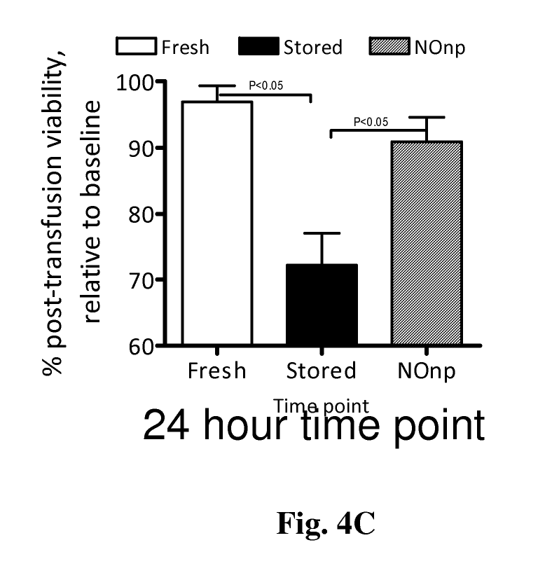

FIGS. 4(A)-(C) further show the viability of NOnp treated RBCs. The hematocrit and percentage of hematocrit transfused of transfused blood for fresh blood, and 21 days old rat's stored blood with and without NO supplementation using NOnp are shown in FIGS. 4(A) and (B). After a period of 24 hours, NOnp treated blood retains a hematocrit transfusion rate of approximately 15% relative to baseline, where stored blood's hematocrit transfusion rate is approximately 12%. A blood sample's hematocrit is integral because it is correlated with its ability to deliver oxygen. Stored blood without NOnp loses this ability more quickly and thus ages faster. NOnp supplementation preserves circulation time of stored cells relative to untreated stored cells. This example further shows that NOnp treated blood has great promise for widespread use to combat morbidity because current FDA standards require that 75% of transfused RBCs must remain in circulation 24 hours after transfusion. In this example, as shown in FIG. 4(C) more than 90% of RBCs treated with NOnp remained in circulation.

NO-np Supplementation:

NO releasing nanoparticles were added to the blood at 10 mg per 125 mL of whole blood. Stored blood was treated with the nanoparticles once every 48 hours at the above described dosing over a period of 21 days for the in vivo transfusion studies. The storage lesion studies were extended to a period of 6 weeks.

The inclusion of the NO releasing nanoparticles into the stored blood results in slower decline, relative to the untreated stored samples, of all measured parameters associated with red blood cells. These parameters include indices of cell rigidity (elongation indices) as well a physiological and biochemical parameters. Increased cell rigidity is associated with enhanced rates of clearance of red blood cells by the spleen. Most significant is the reduced amount of microparticles observed for the nanoparticle treated blood. Microparticle formation is a proposed mechanism for the pro-inflammatory nature of stored blood. The results with the stored blood are consistent with the lower rates of micropartical formation and the slower loss of membrane flexibility induced by the nanoparticle treatment translating into improved function and survivability in the transfused.

### 6.2 EFFICACY OF NOnp WITH RESPECT TO PHYSICAL AND BIOCHEMICAL PARAMETERS

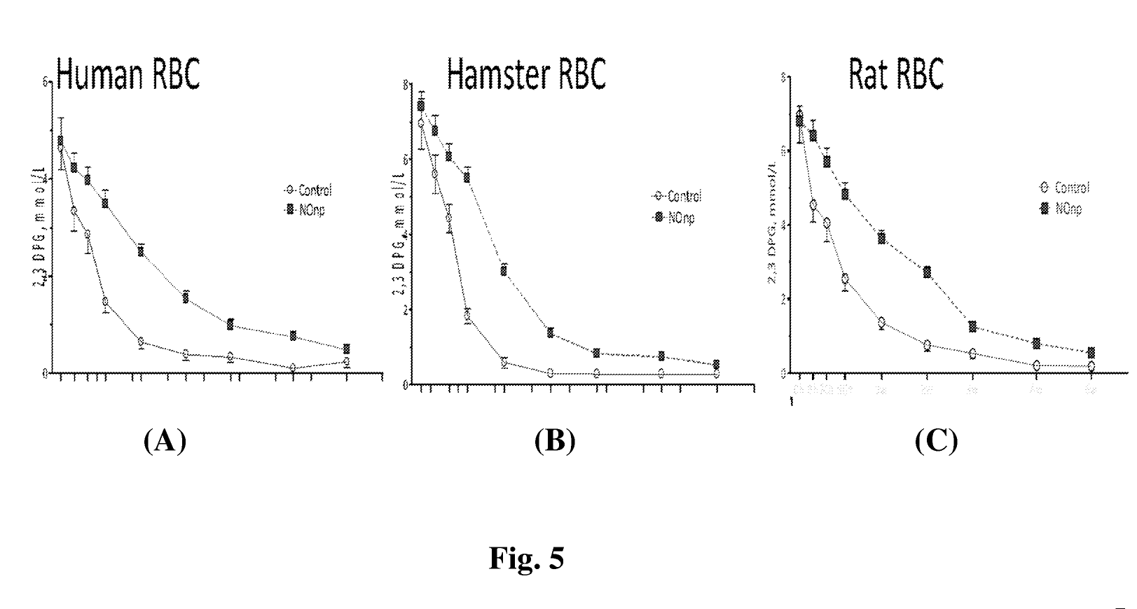

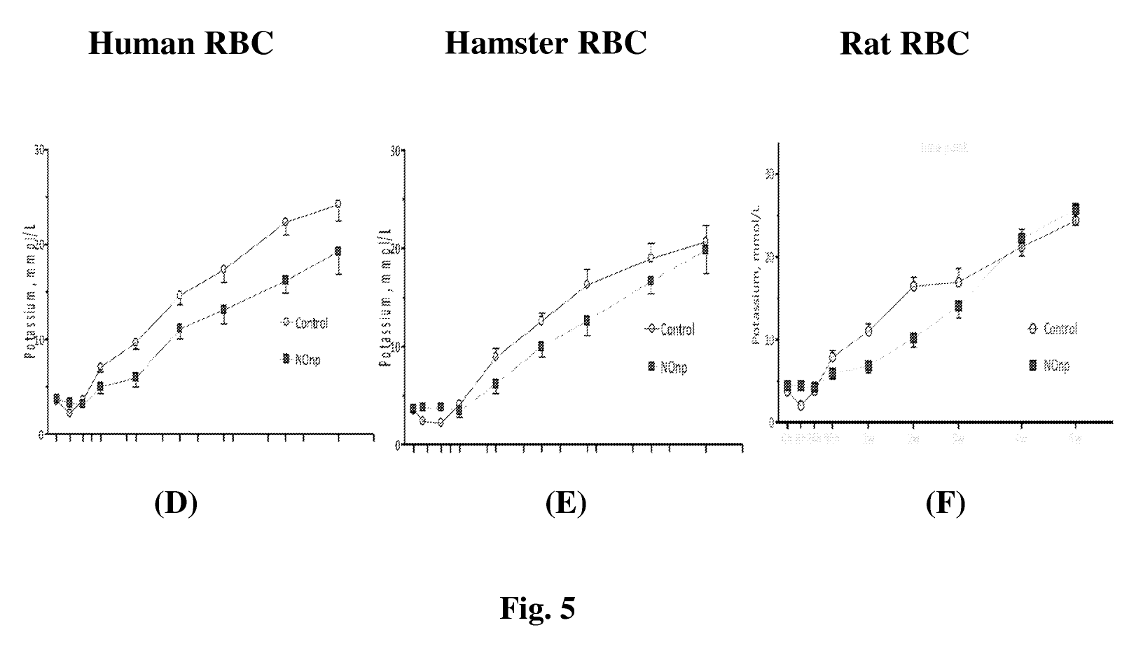

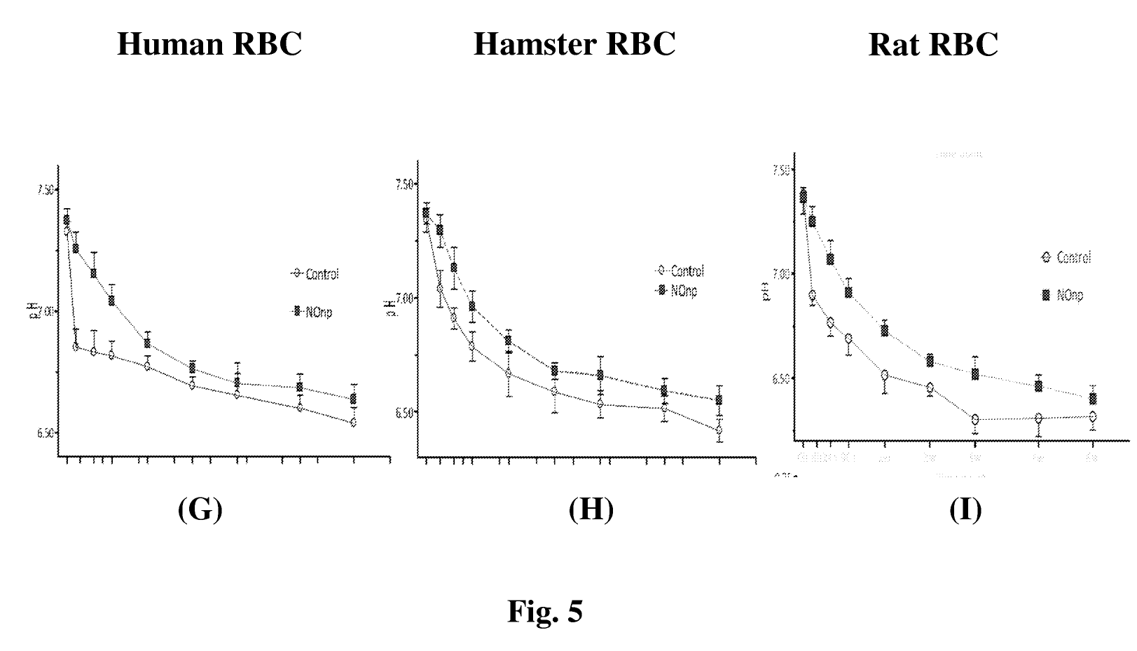

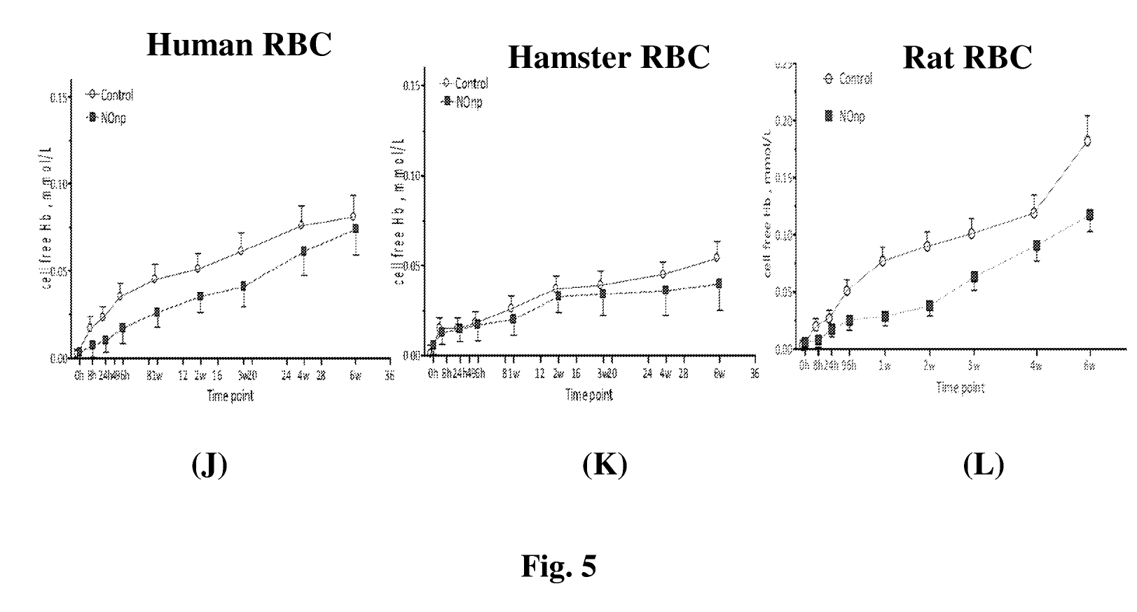

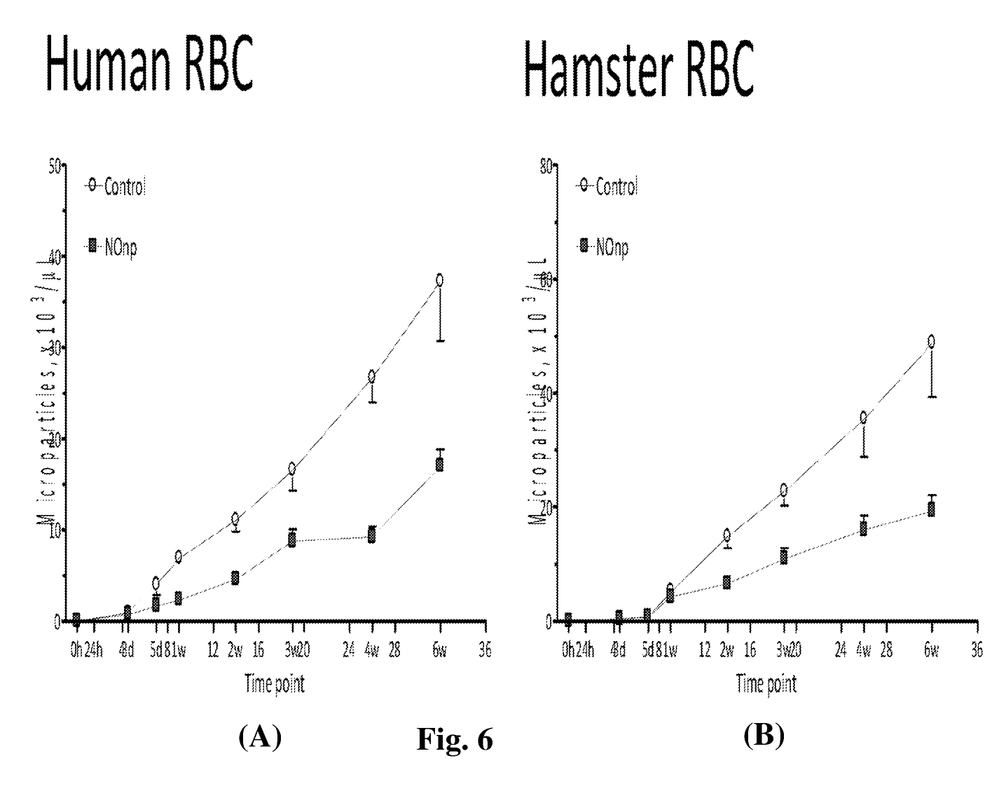

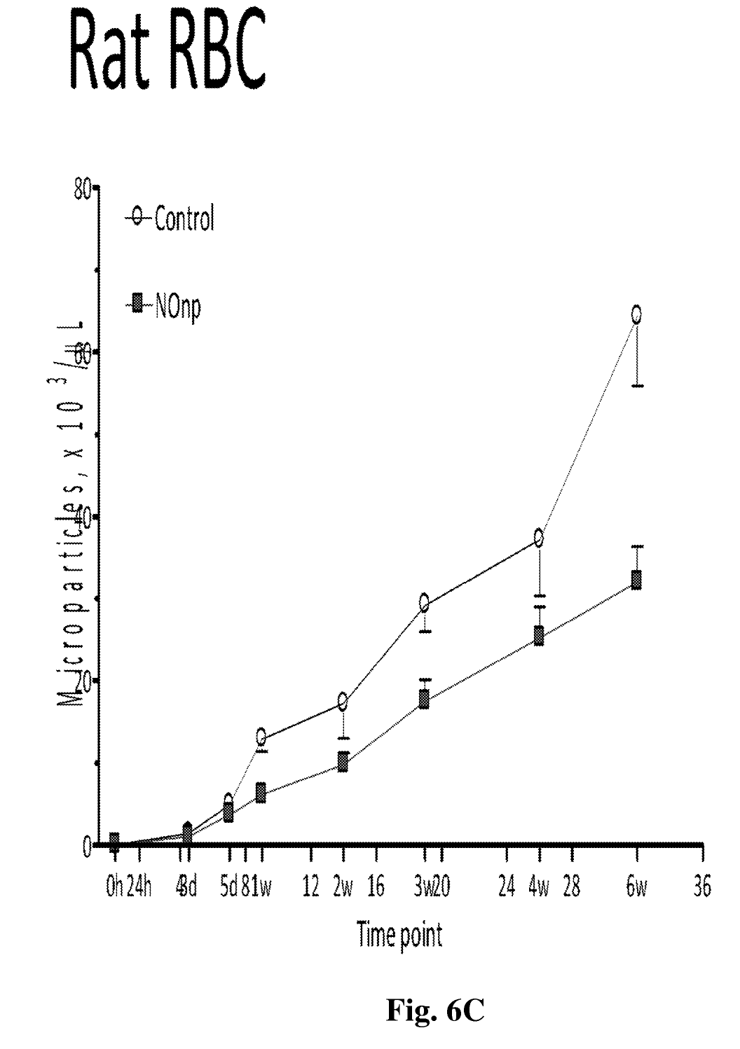

In this example, the procedure was substantially the same as Example 6.1, except that transfused blood was stored for 42 days, and included human, hamster, and rat blood. FIGS. 5(D)-(F) show potassium levels and hemolysis over a six week period. In all species, treatment of RBCs with NOnp during storage prevented 2,3 DPG rapid decrease, slowed down potassium levels, prevented rapid acidification, and did not increase the levels of free hemoglobin (hemolysis). As shown in FIGS. 6(A)-(C), treatment with NOnp also reduced the formation of microparticles in stored blood.

Human RBC units were purchased from the San Diego Blood bank. Blood were preserved in blood collection bags and kept at 4° C.

Blood was obtained from donor rats (˜300 g) Animals were anaesthetized (pentobarbital 60 mg/kg ip) and a femoral catheter (PE-50) was implanted and blood was drawn into 10 mL syringes containing 1.5 mL of citrate, phosphate, dextrose adenine solution (CPDA-1). Blood was leukoreduced, by passing through a neonatal high efficiency leukocyte reduction filter Purecell NEO (Pall Company, East Hills, N.Y.). The leukoreduced blood was centrifuged for 10 minutes at 1350 rpm and supernatant was partially removed to achieve approximately 75% Hct. Packed cell were transferred under sterile conditions to a preservative free blood collection tube and kept at 4° C.

Blood was obtained from donor hamsters (˜80 g). Hamsters were anaesthetized (pentobarbital 60 mg/kg ip) and femoral catheter implanted. The blood from three hamsters was drawn into 10 mL syringes containing 1.5 mL CPDA-1, then leukoreduced as described before and centrifuged. Hamster packed cells were preserved in blood collection tube and kept at 4° C.

Further, in this example, there have not been any adverse observations with either intraperitoneal or intravenous administration. Using NO nanoparticles in stored blood has not been shown to increase toxicity associated with blood transfusions.

### 6.3 EFFECTS ON RBC METABOLISM DURING STORAGE

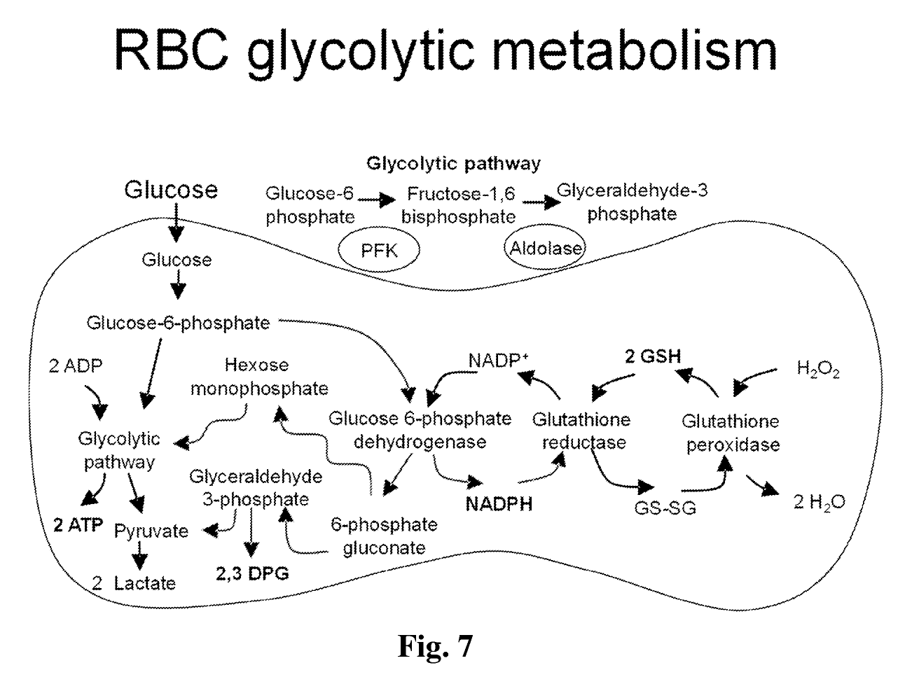

In this example, the glyocotic metabolic mechanism was tested in stored blood. FIG. 7 shows the RBC glycotic metabolism mechanism. The main metabolic pathway of RBC is glycolysis and is primarily fueled by glucose. Glucose enters a RBC and is metabolized to produce ATP, and also pyruvate which in turn is converted to lactate. Glucose which does not follow the glycolytic pathway is metabolized along the hexose monophosphate pathway. This pathway serves primarily to reduce nicotinamide adenine dinucleotide phosphate (NADPH). In conjunction with the glutathione reductase/peroxidase system, NADPH maintains the sulfhydryl groups of globin in their reduced state.

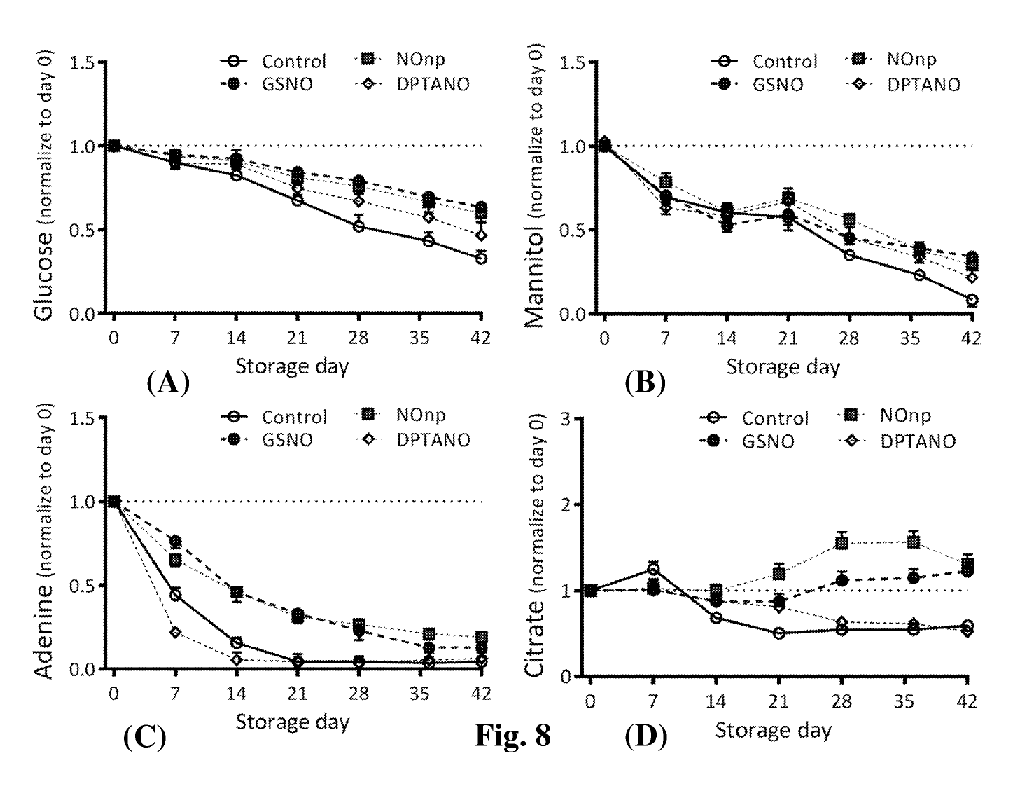

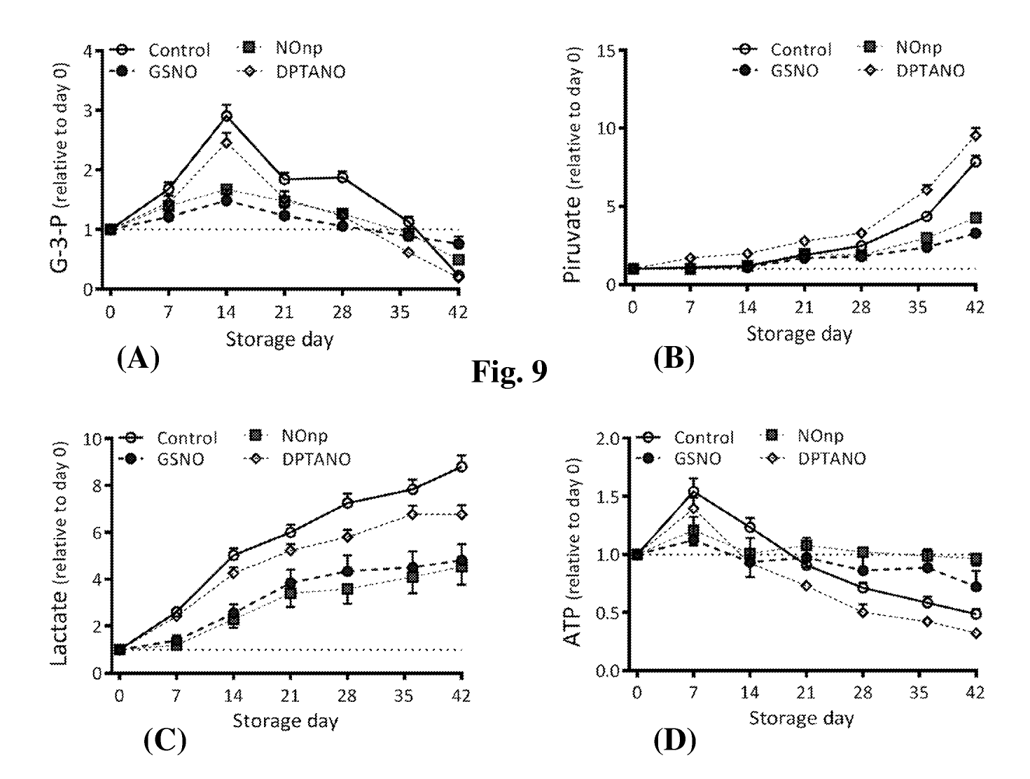

In order to test RBC metabolism, four sets of stored RBCs were tested: RBCs treated with NO releasing nanoparticles (NOnp), RBCs treated with the S-nitrosothiol derivative of glutathione (GSNO), RBCs treated with NONOates (DTPANO), and a control group of RBCs that were not supplemented. GSNO, which due to its long half-life and ability to transnitrosate, has greater antimicrobial activity then NOnp alone against clinical isolates of gram positive and negative multi drug resistant pathogens. Given both the extended bioactive lifetime of GSNO compared to free NO and the potential differences in target tissues/cells and the success achieved with the NO releasing nanoparticle platform, it was undertaken to produce nanoparticles that were similar in character and structure, but with the capability of either releasing GSNO species or transferring NO via S-transnitrosation. FIGS. 8(A)-(D) show the behavior of various elements of the first step of the glycotic pathway over a period of 42 days. As shown in FIG. 8(A), glucose in blood treated with NOnp, GSNO, and DPTANO followed a similar pattern as the control blood, albeit maintaining slightly higher amounts of glucose. FIGS. 8(B)-(D) show the amount of adenine, mannitol, and citrate respectively. Each of NOnp, GSNO, and DPTANO retained higher amounts of each component than the control over the measured timeframe. This is important because these components help RBCs resynthesize the energy carrier adenosine triphosphate (ATP). ATP is a key component in extending the shelf life of stored blood. FIGS. 9(A)-(D) depict the key components in the next step of the glycotic pathway, wherein ATP is created and pyruvate is produced and then converted to lactate. The longevity of stored blood increases as more ATP is produced and less pyruvate and lactate is produced. As shown in FIGS. 9(B) and (C), the control produces much more pyruvate and lactate over 42 days than NOnp, GSNO, and DPTANO. As shown in FIG. 9(D), NOnp and GSNO produce more ATP than the control, whereas DPTANO only produces slightly less than the control. Overall, NOnp and GSNO treated RBC are much slower to lose initial metabolic markers of RBC health than both untreated RBCs and those treated with NONOates.

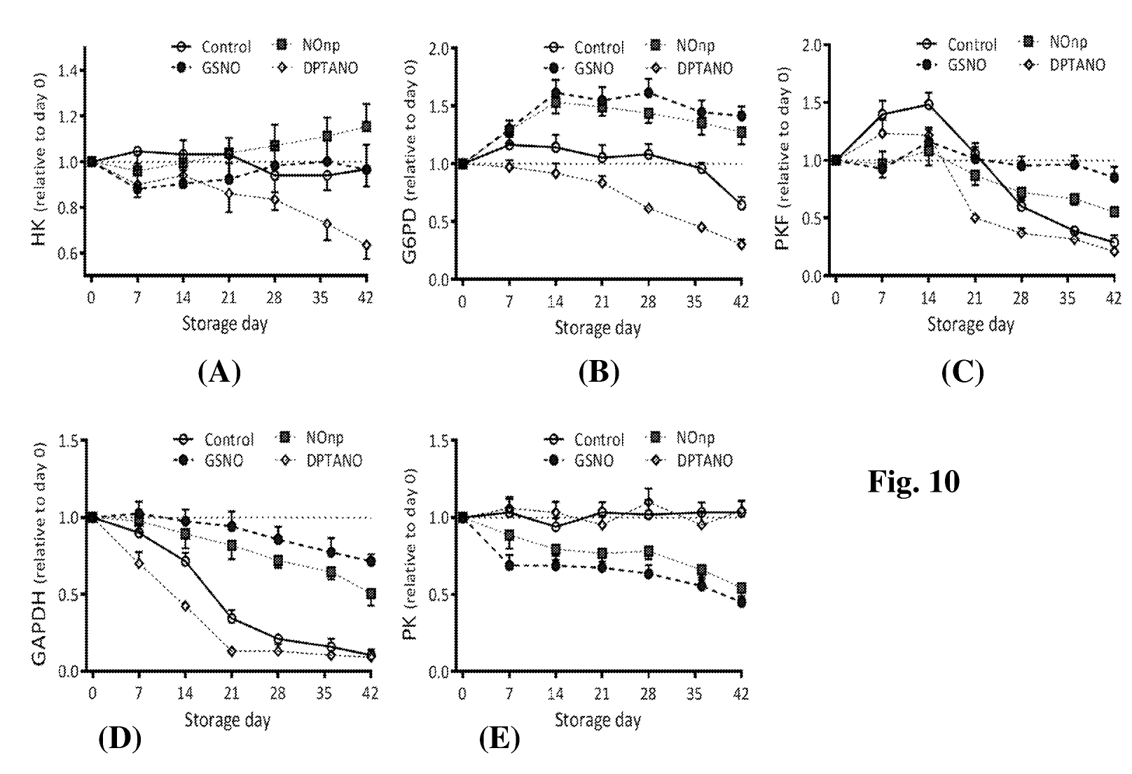

FIGS. 10(A)-(E) detail the behavior of other key elements of the glycolytic metabolic mechanism. In each of hexokinase (HK), glyceraldehyde 3-phosphate dehydrogenase (GAPDH), glucose-6-phosphate dehydrogenase (G6PD), pyruvate kinase (PK), and phosphofructokinase (PFK), both the NOnp and GSNO supplemented blood maintained or even enhanced the key elements of the glycolytic pathway relative to the control and the NONOate treated samples compared to the control blood.

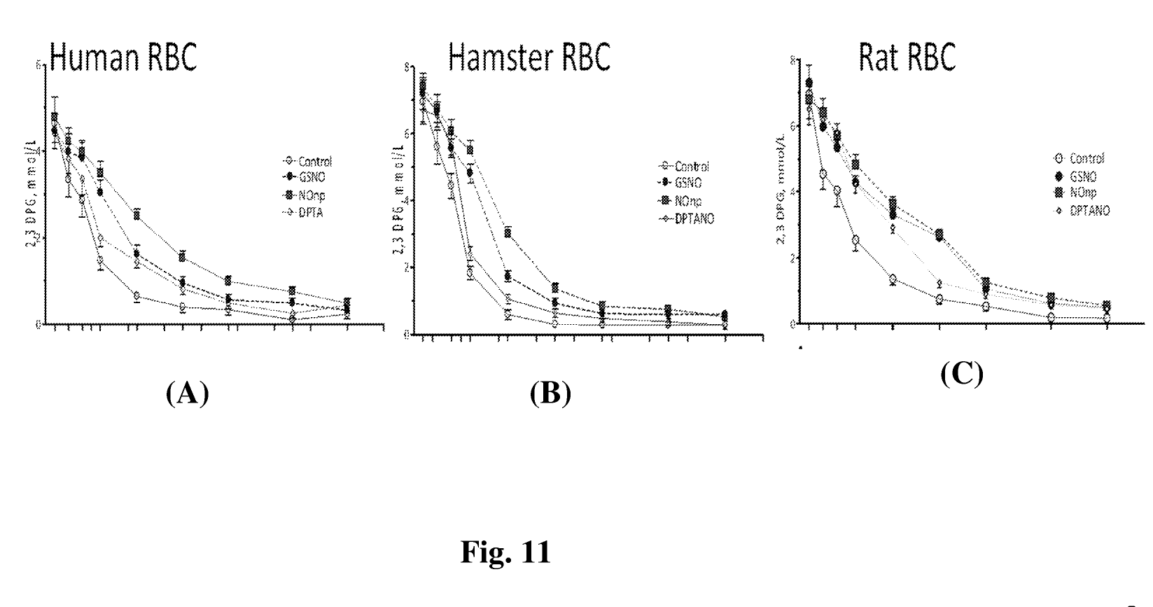

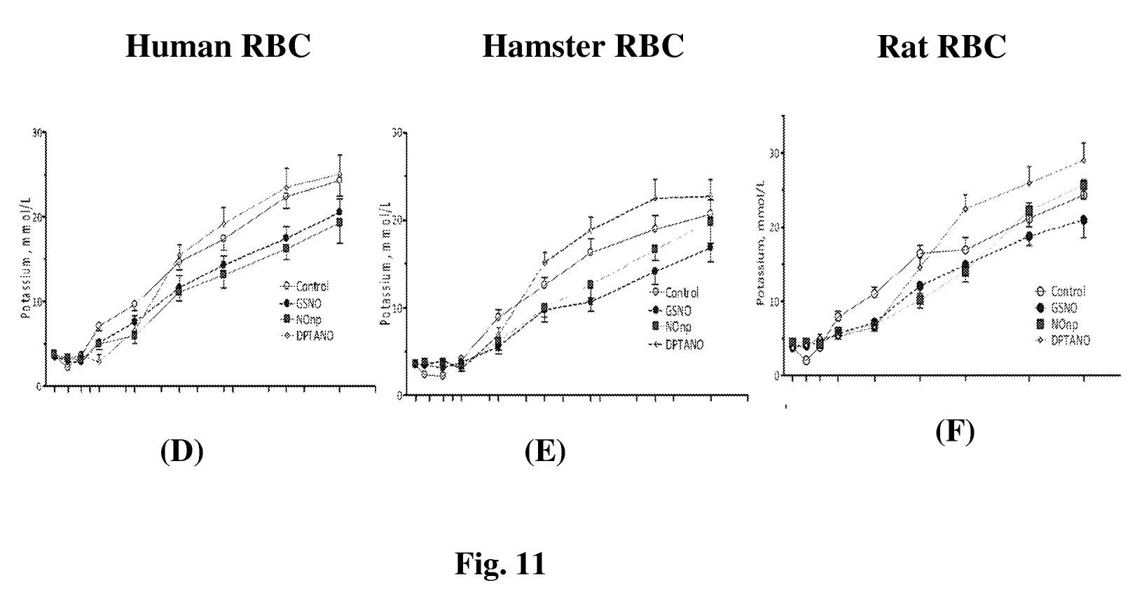

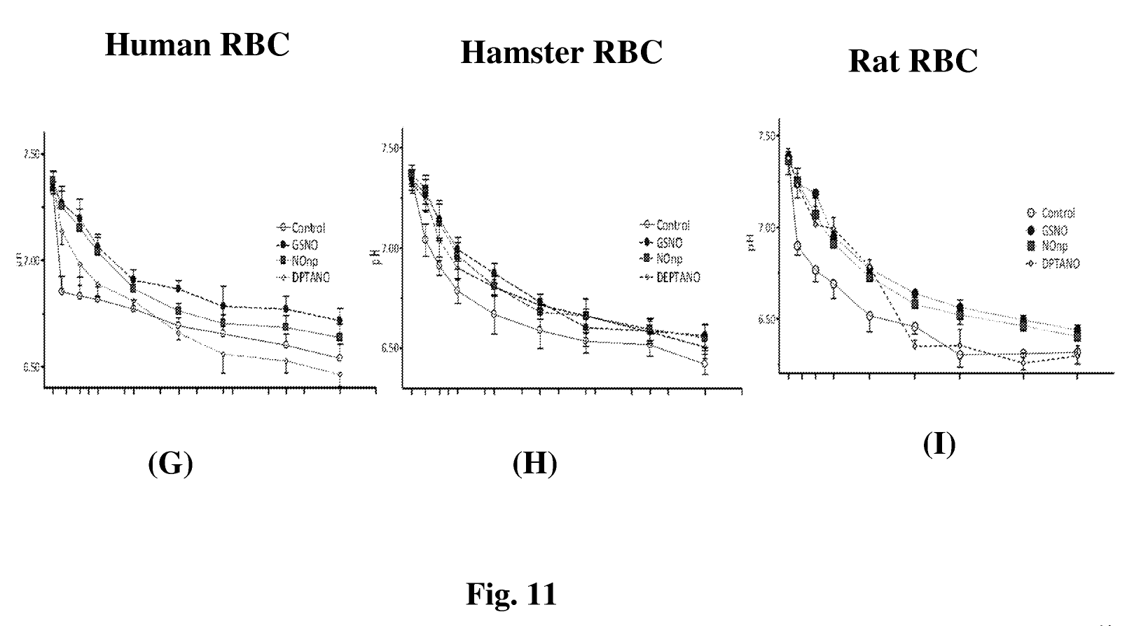

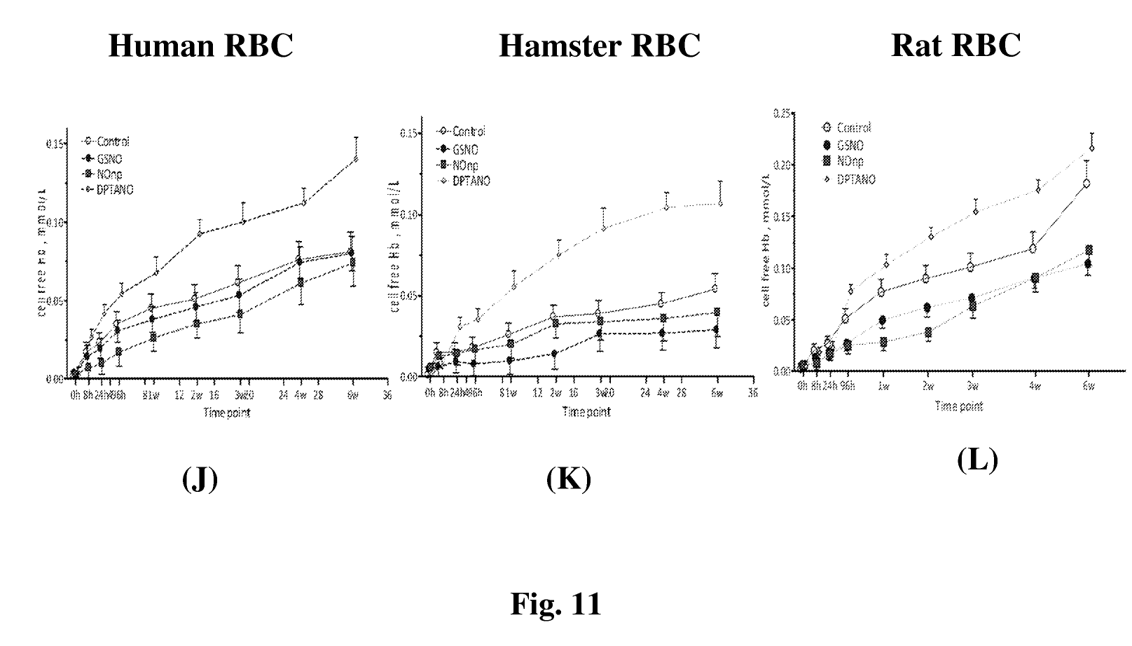

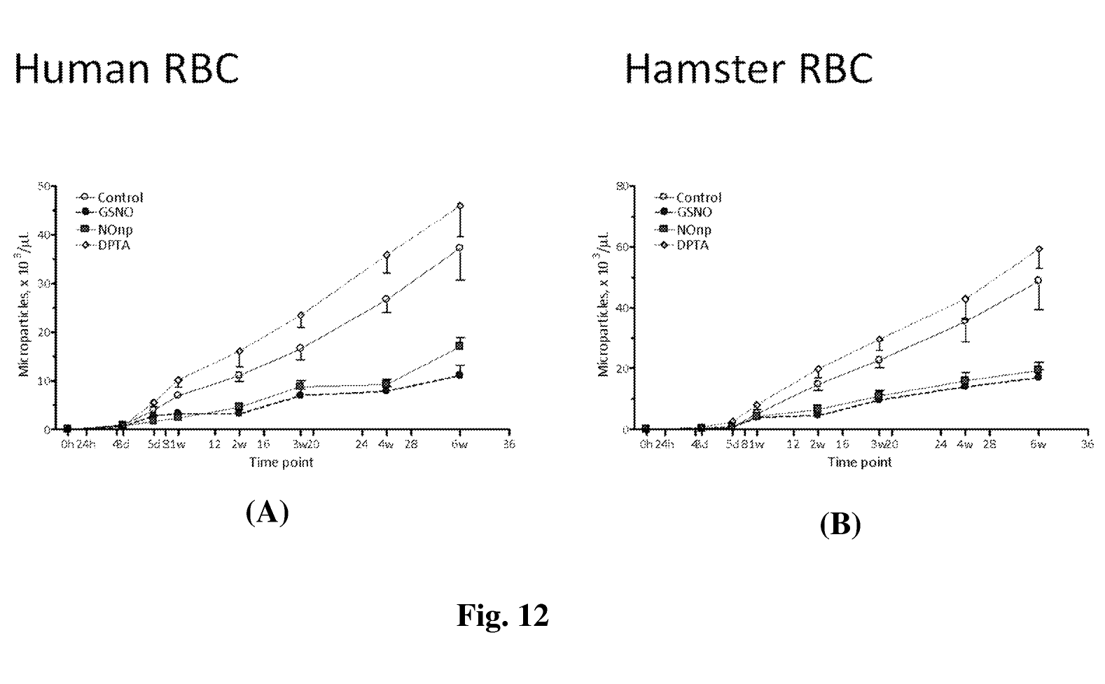

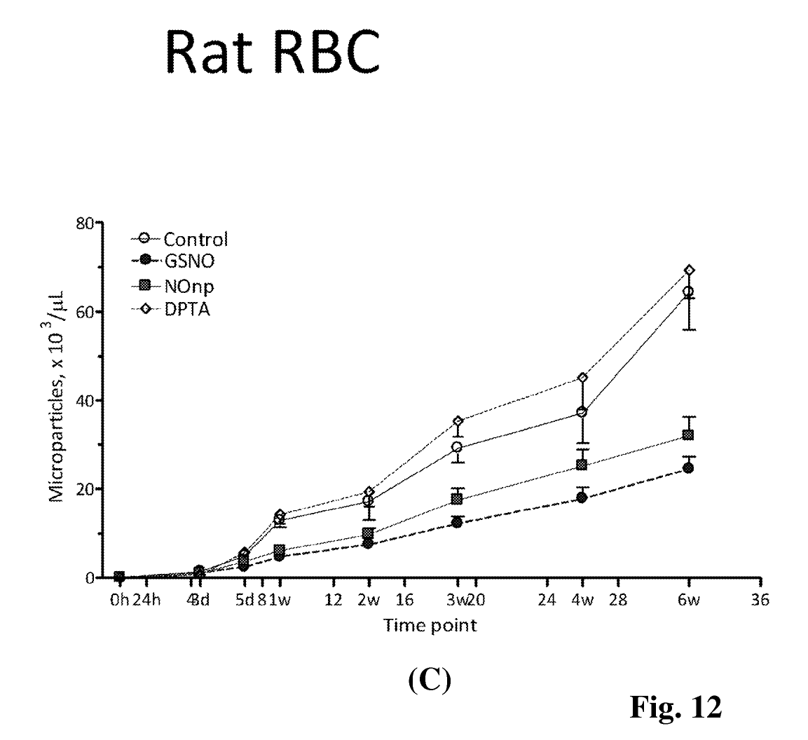

As was shown for NOnp and a control in FIGS. 5(A)-(C), FIGS. 11(A)-(L) show further include the levels of 2,3 DPG, potassium, pH, and free hemoglobin for GSNO and DPTANO. This was measured transfused blood was stored for 42 days, and included human, hamster, and rat blood. In all species, treatment of RBCs with GSNO during storage prevented 2,3 DPG rapid decrease, slowed down potassium levels, prevented rapid acidification, and did not increase the levels of free hemoglobin (hemolysis). However, supplementation with DPTANO only prevented 2,3 DPG rapid decrease, whereas regarding potassium levels, pH levels, and levels of free hemoglobin, it either did not significantly differentiate from the control, or performed worse with these measurements. As shown in FIGS. 12(A)-(C), NOnp and GSNO also reduced microparticle formation associated with inflammation, therefore making the RBC more stable. However, DPTANO faired similarly or worse than the control at this. DPTANO's result in more met Hb formation and NO is released. The enhanced efficacy of the NOnp is derived from the mode of NO production which includes forms of NO (dinitrogentioxide) that can effectively nitrosate thiols and possibly generate nitro-fatty acids in the red cell membrane (that stabilizes the membrane by limiting lipid peroxidation).

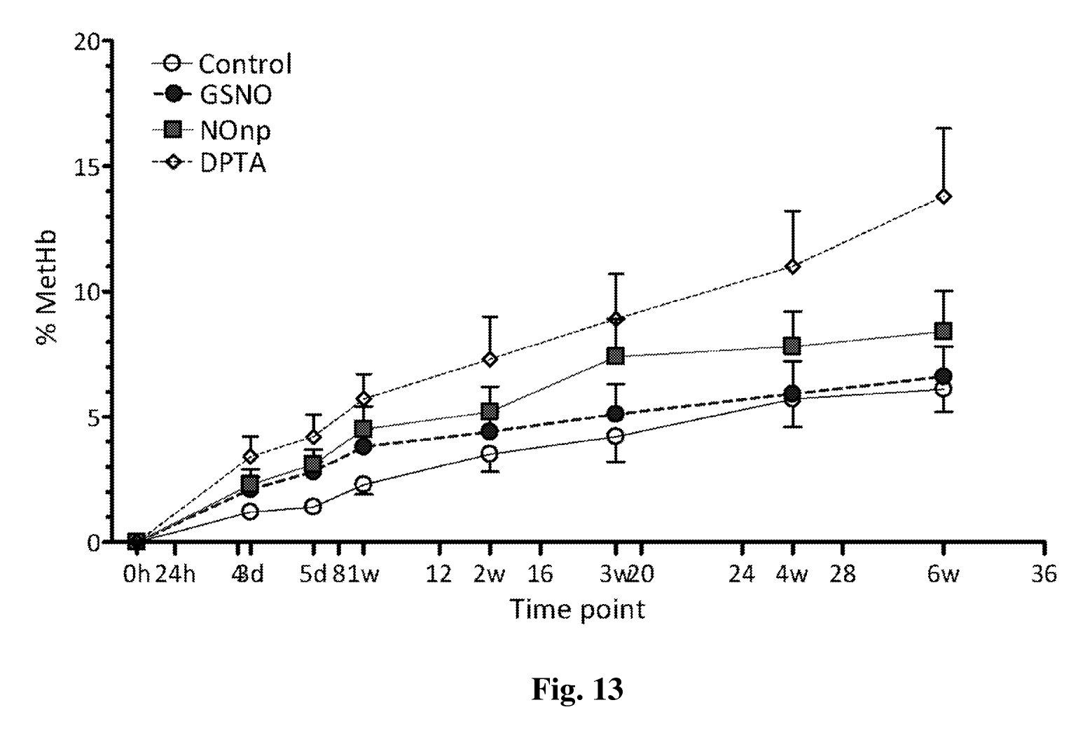

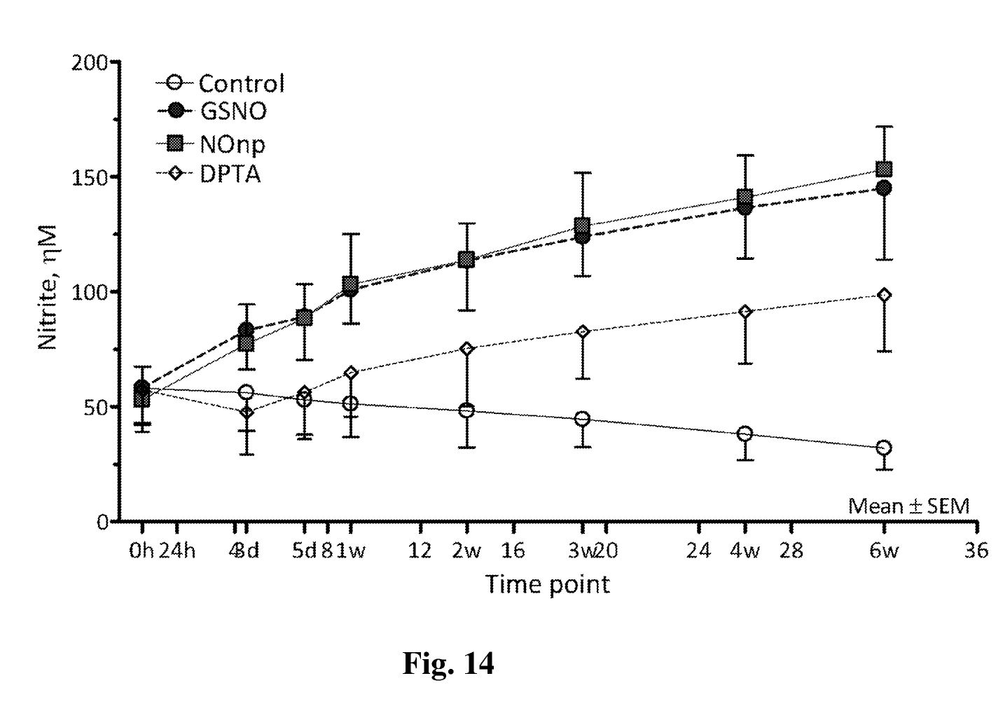

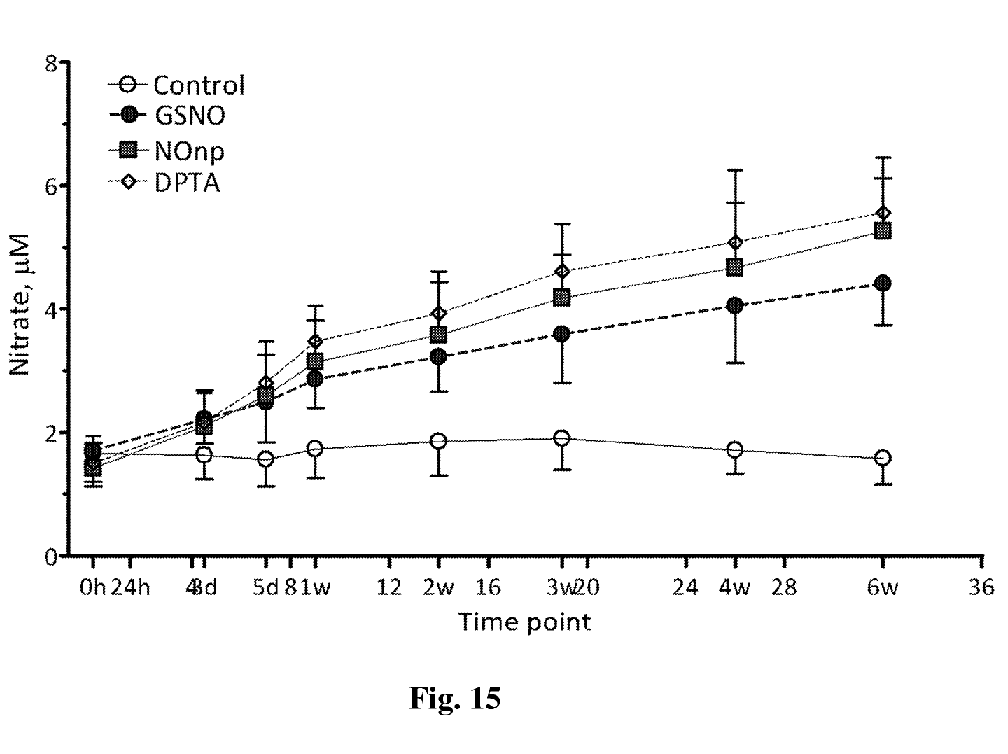

In this example, the buildup of methemoglobin (MetHb), plasma nitrite and plasma nitrate was also measured over a period of six weeks. As shown in FIG. 13, the percentage of MetHb is less for NO releasing nanoparticles (NOnp, GSNO) than NONOates like DPTA. NOnp and GSNO did not generate significantly more MetHb than the control. Nitrite levels were measured because higher nitrate levels are associated with positive RBC health and functionality. As shown in FIGS. 14 and 15, the nitrite and nitrate levels of NO-supplemented blood were much higher than the control. NO supplementation limits the progressive loss of nitrite and nitrate in RBCs, and such loss of nitrite and nitrate has been correlated with an increase in oxidative damage.

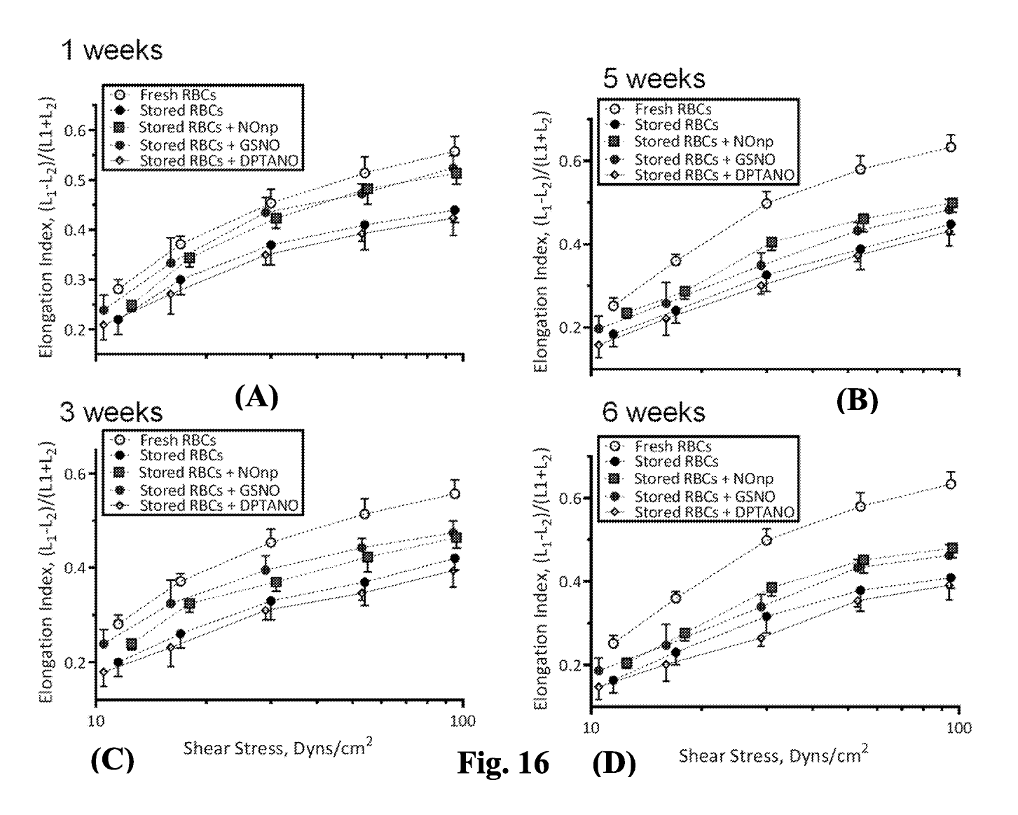

In this example, as shown in FIGS. 16(A)-(D), RBC flexibility is slowed for RBCs treated with NOnps and GSNO. At points of 1 week, 3 weeks, 5 weeks, and 6 weeks, NOnp and GSNO treated blood remained more flexible than untreated and DPTANO treated blood. The performance of NONOate treated blood did not vary substantially from that of untreated blood. DPTANO increased the formation of met-hemoglobin, reducing blood oxygen carrying capacity.

The following examples refer to the preparation, characterization, and toxicity of NO-releasing nanoparticles in accordance with one or more embodiments of the present application.

### 6.4 SYNTHESIS OF CAPTOPRIL-SNO NANOPARTICLES

In this example, a modified tetramethylorthosilicate (TMOS)-based sol-gel method was used to prepare captopril-SNO-np. Briefly, TMOS (3 mL) was hydrolyzed with 1 mM HCl (0.6 mL) by sonication on an ice-bath. The hydrolyzed TMOS (3 mL) was added to a buffer mixture of 1.5 mL of 0.5% chitosan, 1.5 mL of polyethylene glycol (PEG) 400, and 24 mL of 50 mM phosphate (pH 7.4) containing 0.225 M nitrite and 0.28 M captopril. The mixture was left at room temperature overnight in the dark for polymerization. A pink, opaque sol-gel formed, which was lyophilized and then ball milled in a Pulverisette 6 planetary ball-mill (Fritsch, Idar-Oberstein, Germany) into fine powder. The product was stored at −80° C. until use. In addition, nanoparticles synthesized for the in vivo toxicity assay also included nanoparticles without nitrite and captopril (control-np).

### 6.5 SIZE CHARACTERIZATION OF CAPTOPRIL-SNO NANOPARTICLES

In this example, Captopril-SNO-np size was determined by scanning electron microscopy (SEM), which was congruent with previous data in which our similarly-designed NO-np was measured via transmission electron microscopy (TEM). While previous TEM preparations were imaged to show individual nanoparticles of 10 nm in diameter, our current SEM preparations yielded nanoaggregates of 60-80 nm in diameter (measured from 100 nanoaggregates). However, individual nanoparticles could be visualized within many of the nanoaggregates which were also approximately 10 nm in diameter. Dynamic light scattering (DLS) of 2.5 mg/mL Captopril-SNO-np revealed an average hydrodynamic diameter of 377.8 nm based on 40 acquisition attempts. The standard deviation was 16.4 nm (4.3%), proving that Captopril-SNO-np are homogenous in size. Since Captopril-SNO-np swell with moisture, the average diameter by DLS is likely an overestimation of their dry size, and is also likely to be a better approximation of their actual size in vivo.

### 6.6 NO RELEASE PROFILE OF CAPTOPRIL-SNO NANOPARTICLES

In this example, the time course of NO formation from Captopril-SNO-np in PBS (1 mg/mL) was evaluated over 12 hours via chemiluminescent NO analyzer. Within 2 minutes, the NO concentration peaked rapidly at 11.1 μM, and fell to levels below 4 μM after 4 minutes. NO concentration stabilized at about 2.4 μM after 19 minutes and decayed to a final concentration of about 1.2 μM after 12 h, thus demonstrating sustained NO release over at least 12 hours.

### 6.7 IN VIVO TOXICITY ASSAY OF CAPTOPRIL-SNO NANOPARTICLES

In this example, zebrafish embryos (Danio rerio, wild type, 5D-Tropical strain) were obtained from Sinnhuber Aquatic Research Laboratory, Oregon State University, and exposures and evaluations were conducted according to Truong et al., 2011. Briefly, embryos were dechorionated at 6 hours post-fertilization (hpf) by Protease Type XIV (Sigma Aldrich). Control-np, Alexa 568-np, and Captopril-SNO-np were each diluted to 0, 0.016, 0.08, 0.4, 2, 10, 50 and 250 ppm in fish water and vortexed. Each well of a 96-well plate was filled with 150 μL of a given dilution, in addition to one zebrafish embryo at 8 hpf (N=24 for each dilution). The plates were sealed with Parafilm and incubated at 26.5° C. on a 14 h light:10 h dark photoperiod.

Exposures were conducted over 5 days of development which encompasses gastrulation through organogenesis, the periods of development most conserved among vertebrates. All organ systems begin functioning during this time period and all of the molecular signaling pathways are active and necessary for normal development to occur. At 24 hpf, embryos were examined for mortality, developmental progression, notochord development, and spontaneous movement. At 120 hpf, the following larval morphology and behavioral endpoints were examined: body axis, eye, snout, jaw, otic vesicle, heart, brain, somite, pectoral fin, caudal fin, yolk sac, trunk, circulation, pigment, swim bladder, motility and tactile response. Effects were evaluated in binary notation as either present or not present. Untreated control and exposed groups were compared using Fisher's exact test for each endpoint, and p-value<0.05 for significance.

Results:

the embryonic exposures did not elicit any toxic responses in the zebrafish after 5 days of exposure during a sensitive developmental time period. No nanoparticle treatments were significantly different from untreated controls with respect to mortality, morphology or behavior. Background mortality is maintained below 8.3% in the Harper Laboratory (Oregon State University), which is below the EPA ecological effects test guideline of 10%. Mortality did not differ between groups and was not significantly different than background for any exposure. There were no significant behavior abnormalities in the exposed zebrafish at 24 hpf or 120 hpf, as shown by normal patterns of spontaneous movement and standard touch responses.

### 6.8 PREPARATION AND CHARACTERIZATION OF NO-RELEASING NANOPARTICLES (NO-np) WITH BOTH ALCOHOL AND ADDED AMINOSILANE

In this example, the NO-np were prepared using the following sequence of steps: 1) Hydrolyzing Tetramethylorthosilicate (TMOS): Stock of 5 ml of TMOS, 600 μl of deioinized water, and 560 μl of 2 mM hydrochloric acid were added to a small vial. The contents of the vial were sonicated for approximately 20-30 minutes yielding a clear solution that was then placed on ice. 2) Mixing the sol-gel components: 1.49 g of sodium nitrite were dissolved in 4 ml of PBS buffer at pH 7.5 followed by sequential addition and mixing of 0.5 ml of PEG-200, 500 μl of chitosan (1 mg/ml), and 34 ml of methanol. The resulting mixture was then vortexed thoroughly. Then, 2 ml of previously hydrolyzed TMOS was added to the solution along with approximately 50-75 μl of 3-aminopropyltrimethoxysilane followed by vigorous vortexing until complete gelation. 3) Lyophilizing the sol-gel: The resulting gelled material was then lyophilized for 24-48 hrs which removed all volatile components including the methanol. 4) Ball-Milling the lyophilized sol-gel: Following lyophilization the dry material was ball milled at 150 rpm for 8 hours.

NO-np Characterization of Platform with Alcohol and Added Aminosilane:

The resulting NO-np was a very fine white powder with no visible granularities. With scanning EM, results showed nanoparticles with a mean diameter of 55.6±14.8 nm. DLS analysis demonstrated a relatively narrow distribution of sizes for the NO-np, that is centered at 226.5 nm based on 40 acquisition attempts. The standard deviation is 8.9, proving that NO-np are homogenous in size. Since NO-np swell with moisture, the average diameter is likely an overestimate.

For NO release from NO-np, a peak release concentration was reached at 40.2 minutes, after which a steady state release ranging between 184-196 ppb NO was achieved, with subsequent decline of release rate extending to the end of the investigation at 7.2 hours. Measurements at lower pH values showed only very small changes in the releasing profiles, suggesting that very limited amounts of residual nitrite remain in the nanoparticles (nitrite converts to NO at low pH).

During the preparation (just prior to after gelation but prior to the lyophlization), evaluation of NO release via GSNO (the S-nitrosothiol derivative of glutathione) production from GSH (glutathione) showed no release of NO at this stage of preparation for the new platform when both alcohol and aminopropyltrimethoxysilane are used.

The invention is not to be limited in scope by the specific embodiments described herein. Indeed, various modifications of the invention in addition to those described will become apparent to those skilled in the art from the foregoing description and accompanying figures. Such modifications are intended to fall within the scope of the appended claims.

All references cited herein are incorporated herein by reference in their entirety and for all purposes to the same extent as if each individual publication or patent or patent application was specifically and individually indicated to be incorporated by reference in its entirety for all purposes.

### REFERENCES

1. Han, G., Friedman, A. J., and Friedman, J. M. (2010) Nitric oxide releasing nanoparticle synthesis and characterization. Methods Mol Biol 704, 187-195.
2. Friedman, A. J., Han, G., Navati, M. S., Chacko, M., Gunther, L., Alfieri, A., and Friedman, J. M. (2008) Sustained release nitric oxide releasing nanoparticles: characterization of a novel delivery platform based on nitrite containing hydrogel/glass composites. Nitric Oxide 19, 12-20.
3. Cabrales, P., Han, G., Nacharaju, P., Friedman, A. J., and Friedman, J. M. (2011) Reversal of hemoglobin-induced vasoconstriction with sustained release of nitric oxide. Am J Physiol Heart Circ Physiol 300, H49-56.
4. Cabrales, P., Han, G., Roche, C., Nacharaju, P., Friedman, A. J., and Friedman, J. M. (2010) Sustained release nitric oxide from long-lived circulating nanoparticles. Free Radic Biol Med 49, 530-538.
5. Nachuraju, P., Friedman, A. J., Friedman, J. M., and Cabrales, P. (2011) Exogenous nitric oxide prevents cardiovascular collapse during hemorrhagic shock. Resuscitation 82, 607-613.
6. Nacharaju, P., Tuckman-Vernon, C., Maier, K. E., Chouake, J., Friedman, A., Cabrales, P., and Friedman, J. M. (2012) A nanoparticle delivery vehicle for S-nitroso-N-acetyl cysteine: sustained vascular response. Nitric Oxide 27, 150-160.
7. Schairer, D. O., Chouake, J. S., Nosanchuk, J. D., and Friedman, A. J. (2012) The potential of nitric oxide releasing therapies as antimicrobial agents. Virulence 3, 271-279.
8. Schairer, D., Martinez, L. R., Blecher, K., Chouake, J., Nacharaju, P., Gialanella, P., Friedman, J. M., Nosanchuk, J. D., and Friedman, A. (2012) Nitric oxide nanoparticles: Pre-clinical utility as a therapeutic for intramuscular abscesses. Virulence 3, 62-67.
9. Macherla, C., Sanchez, D. A., Ahmadi, M. S., Vellozzi, E. M., Friedman, A. J., Nosanchuk, J. D., and Martinez, L. R. (2012) Nitric oxide releasing nanoparticles for treatment of Candida albicans burn infections. Frontiers in microbiology 3, 193.
10. Friedman, A., Blecher, K., Sanchez, D., Tuckman-Vernon, C., Gialanella, P., Friedman, J. M., Martinez, L. R., and Nosanchuk, J. D. (2012) Susceptibility of Gram-positive and -negative bacteria to novel nitric oxide-releasing nanoparticle technology. Virulence 2, 217-221.
11. Blecher, K., Martinez, L. R., Tuckman-Vernon, C., Nacharaju, P., Schairer, D., Chouake, J., Friedman, J. M., Alfieri, A., Guha, C., Nosanchuk, J. D., and Friedman, A. J. (2012) Nitric oxide-releasing nanoparticles accelerate wound healing in NOD-SCID mice. Nanomedicine: nanotechnology, biology, and medicine 8, 1364-1371.
12. Friedman, A. J., Blecher, K., Schairer, D., Tuckman-Vernon, C., Nacharaju, P., Sanchez, D., Gialanella, P., Martinez, L. R., Friedman, J. M., and Nosanchuk, J. D. (2011) Improved antimicrobial efficacy with nitric oxide releasing nanoparticle generated 5-nitro soglutathione. Nitric Oxide 25, 381-386.
13. Mordorski, B., Pelgrift, R., Adler, B., Krausz, A., Batista da Costa Netob, A., Liangc, H., Gunther, L., Clendaniel, A., Harper, S., Friedman, J. D., Nosanchuk, J. D., Nacharaju, P., Friedman, A. J., (2015) S-nitrosocaptopril nanoparticles as nitric oxide-liberating and transnitrosylating anti-infective technology. Nanomedicine: Nanotechnology, Biology, and Medicine, 11, pp. 283-291
14. Mihu, M. R., Sandkovsky, U., Han, G., Friedman, J. M., Nosanchuk, J. D., and Martinez, L. R. (2010) The use of nitric oxide releasing nanoparticles as a treatment against Acinetobacter baumannii in wound infections. Virulence 1, 62-67.
15. Martinez, L. R., Han, G., Chacko, M., Mihu, M. R., Jacobson, M., Gialanella, P., Friedman, A. J., Nosanchuk, J. D., and Friedman, J. M. (2009) Antimicrobial and healing efficacy of sustained release nitric oxide nanoparticles against Staphylococcus aureus skin infection. J Invest Dermatol 129, 2463-2469.
16. Han, G., Martinez, L. R., Mihu, M. R., Friedman, A. J., Friedman, J. M., and Nosanchuk, J. D. (2009) Nitric oxide releasing nanoparticles are therapeutic for Staphylococcus aureus abscesses in a murine model of infection. PLoS One 4, e7804.
17. Truong L, Harper S L, Tanguay R L. Evaluation of Embryotoxicity Using the Zebrafish Model. In: Gautier J-C, ed. Drug Safety Evaluation: Methods and Protocols. Vol 691. New York, N.Y.: Humana Press; 2011:271-279.
18. Ecological Effects Test Guidelines: OPPTS 850.1075 Fish Acute Toxicity Test, Freshwater and Marine. United States Environmental Protection Agency; 1996.

What is claimed is:

1. A blood storage and/or rejuvenating composition comprising an anticoagulant and a hydrogel-based nanoparticle, wherein the nanoparticle releases nitric oxide (NO), nitrosothiol, nitrofatty acid, dinitrogen trioxide, a diazeniumdiolate (NONOate), or a combination thereof.

2. The composition of claim 1, wherein the composition further comprises plasma, red blood cells or whole blood.

3. The composition of claim 1, wherein the composition is a non-aqueous solution.

4. The composition of claim 3 wherein the red blood cells or blood in the composition is rejuvenated as compared to red blood cells or blood that has not been contacted with the nanoparticles.

5. A method of storing blood or reducing toxicity associated with blood from a transfusion, the method comprises contacting the blood with the composition of claim 1.

6. The method of claim 5, wherein a red blood cell's lifespan in the blood in circulation is increased.

7. The method of claim 5, wherein degradation of a red blood cell in the blood is slowed.

8. The method of claim 5, wherein the composition enhances tissue perfusion.

9. The method of claim 5 wherein red blood cells from the blood have been damaged by blood fractionation, a filtration procedure, or a pathogen inactivation treatment.

10. A method of reducing infective organisms in stored blood comprising contacting the blood with the composition of claim 1.

11. The method of claim 10, wherein the infective organisms are bacteria, fungi, trypanosomes, or a combination thereof.

12. A method of rejuvenating blood, the method comprising:
providing red blood cells having a 2,3-diphosphoglycerate value lower than the value for freshly drawn blood;
mixing the red blood cells with a blood storage and/or rejuvenating composition under conditions effective to increase the 2,3-diphosphoglycerate value, wherein the blood storage and/or rejuvenating composition comprises a hydrogel-based nanoparticle that releases nitric oxide (NO).

13. The method of claim 12 wherein the conditions effective comprise incubating the red blood cells in the blood storage and/or rejuvenating composition at a temperature of 4° C. to 37° C.

14. The method of claim 12 wherein the temperature is room temperature.

15. The method of claim 12 wherein conditions effective comprise incubating the cells in the blood storage and/or rejuvenating composition for a time of at least 10 minutes.

16. The method of claim 12 wherein the red blood cells are packed red blood cells or in whole blood.

17. A method of rejuvenating blood, the method comprising:
providing red blood cells having an adenosine triphosphate value lower than the value for freshly drawn blood;
mixing the red blood cells with a blood storage and/or rejuvenating composition under conditions effective to increase the adenosine triphosphate value,
wherein the blood storage and/or rejuvenating composition comprises a hydrogel-based nanoparticle that releases nitric oxide (NO).

18. A method of rejuvenating blood, the method comprising:
providing red blood cells having an reduced functional capillary density (FCD) lower than the value for freshly drawn blood;
mixing the red blood cells with a blood storage and/or rejuvenating composition under conditions effective to increase the FCD,
wherein the blood storage and/or rejuvenating composition comprises a hydrogel-based nanoparticle that releases nitric oxide (NO).

19. A method of rejuvenating blood, the method comprising:
providing red blood cells having a reduced plasma nitrite or plasma nitrate level lower than the value for freshly drawn blood;
mixing the red blood cells with a blood storage and/or rejuvenating composition under conditions effective to increase the plasma nitrite or plasma nitrate level,
wherein the blood storage and/or rejuvenating composition comprises a hydrogel-based nanoparticle that releases nitric oxide (NO).

20. The composition of claim 1 wherein the concentration of nanoparticles is 0.01-0.02, 0.02-0.05, 0.05-0.08, 0.08-0.1, 0.1-0.12, 0.12-0.15, 0.15-0.18, 0.18-0.2, 0.2-0.23 or 0.23-0.25 mg/ml.
